(19) United States
(12) Patent Application Publication
(10) Pub. No.: US 2003/0174177 A1
(43) Pub. Date: Sep. 18, 2003

(54) Printing apparatus, menu-adding method for the printing apparatus, printing system, and storage media

(75) Inventors: Hideyuki Tsukuda, Matsumoto-shi (JP); Yasuhide Anbiru, Tokyo (JP); Ko Kojima, Tokyo (JP); Yoichi Hine, Tokyo (JP); Shinji Ishizuka, Tokyo (JP); Nobuyuki Horii, Tokyo (JP); Takuya Suetani, Tokyo (JP)

Correspondence Address: HOGAN & HARTSON L.L.P., 500 S. GRAND AVENUE, SUITE 1900, LOS ANGELES, CA, 90071-2611, US

(73) Assignee: Seiko Epson Corporation

(21) Appl. No.: 10/365,616

(22) Filed: Feb. 12, 2003

(30) Foreign Application Priority Data
Mar. 14, 2002 (JP) 2002-070740

(51) Int. Cl. G09G 5/00

(52) U.S. Cl. 345/810

(57) ABSTRACT

There are provided a printing apparatus which is capable easily adding menu options and image elements made selectable via the menu options for use in forming a print image, a menu-adding method for the printing apparatus, a printing system incorporating the printing apparatus, as well as storage media storing programs for the printing apparatus and the menu-adding. The printing apparatus forms a print image having an image element selected from a displayed menu, arranged therein. A receiving device receives additional menu data from a predetermined other end of communication, the additional menu data including information of an additional menu option which can be added as a menu option of the menu display, and information of image elements displayed as options hierarchically under the additional menu option. An additional menu-storing device stores the additional menu data. A menu-incorporating device incorporates into the menu display the additional menu option and the image elements hierarchically under the additional menu option, based on the additional menu data.

### BACKGROUND OF THE INVENTION

1. Field of the Invention

This invention relates to a printing apparatus, a menu-adding method for the printing apparatus, a printing system, and storage media.

2. Description of Related Art

Image elements that form a print image produced by a printing apparatus include image elements which are drawn when the print image is prepared, and image elements which are selected and arranged in the print image when the print image is prepared by using a menu display showing menu options of image elements provided in advance for use. This kind of menu display is employed to select image elements, such as illustrations and the like, for arrangement in a print image when the print image is not a picture, a drawing, or the like, but a character string image formed by characters corresponding to standard character codes of a text code.

However, there are various kinds of image elements used in forming a print image. Further, image elements necessitated are different depending on users or on the situation. As a result, it has been difficult to properly or sufficiently store required image elements in a predetermined ROM or the like, since the storage leads to an increased memory capacity of the ROM, for instance. Further, even if new image elements can be added to a menu, they are only registered at a level hierarchically immediately under an existing menu option, but it has been difficult to add them under the name of a new menu option suitable for the image elements.

### SUMMARY OF THE INVENTION

This invention has an advantage of providing a printing apparatus which is capable easily adding menu options and image elements made selectable via the menu options for use in forming a print image, a menu-adding method for the printing apparatus, a printing system incorporating the printing apparatus, as well as storage media storing programs for the printing apparatus and the menu-adding method.

According to a first aspect of the invention, there is provided a printing apparatus for forming a print image by arranging an image element selected from a displayed menu, in the print image, comprising: receiving means for receiving additional menu data from a predetermined other end of communication, the additional menu data including information of an additional menu option for being added to the displayed menu as a menu option thereof, and information of an image element displayed as an option hierarchically under the additional menu option; additional menu-storing means for storing the additional menu data; and menu-incorporating means for incorporating into the displayed menu the additional menu option and the image element hierarchically under the additional menu option, based on the additional menu data.

According to this printing apparatus, a print image is formed by arranging a desired image element selected from a displayed menu. In doing this, additional menu data including information of an additional menu option for being added to the displayed menu as a menu option thereof and information of an image element displayed as an option hierarchically under the additional menu option is received from a predetermined other end of communication, stored, and incorporated into the menu display. This makes it possible to easily add a menu option and an image element made selectable via the menu option for use in forming a print image. Further, since the menu option and the selectable image element can be easily added to the menu, the user is only required to add the same on an as-needed basis. This makes it possible to reduce the number of menu options and image elements provided as standard options in the menu from the beginning, thereby contributing to the saving of the memory capacity of the apparatus. It should be noted that in this embodiment, the print image may be not only a picture, a drawing, or the like, but also a document (character string image) formed by characters corresponding to standard codes of a text code (JIS code, for instance), and the present invention can be applied to addition of a menu option for arranging an image element, such as an illustration, a symbol, a figure (including a nonstandard character), or the like, in the document. Further, there is no need to store a menu option as a reserved one in view of adding the same in the future before receiving an image element thereof, whereby an unnatural menu display can be avoided. In other words, before additional menu data is received, a menu having no additional menu option included therein is displayed, and after reception of the additional menu data, a menu with an additional menu option included therein is displayed, whereby it is possible to provide a natural and excellent appearance of the menu display before and after reception of additional menu data.

Preferably, the print medium is a tape.

According to this arrangement, since the print medium is a tape, the printing apparatus can be applied to a tape printing apparatus.

Preferably, the receiving means comprises overwriting means for writing new additional menu data over additional menu data having been stored on an immediately preceding occasion.

According to this arrangement, additional menu data having been stored on an immediately preceding occasion can be overwritten by new additional menu data, which makes it possible to replace an additional menu (menu other than a standard menu provided from the beginning) by a new one on an as-needed basis without increasing the memory capacity of the apparatus.

Preferably, the information of the additional menu option is defined by menu tables for defining three kinds of menus formed by a root menu, a lower level menu-designating menu, and a candidate menu, the root menu being a menu which serves as a root from which the additional menu option is searched, the lower level menu-designating menu being a menu which is designated by the root menu or by another of the lower level menu-designating menu at a hierarchically higher level, and used for designating another of the lower level menu-designating menu or the candidate menu, the candidate menu being a menu which is designated by the root menu or the lower level menu-designating menu, and used for designating the image element as the option hierarchically thereunder, after reception of the additional menu data, the additional menu option being displayed by a search made based on the root menu as far as the image element at the hierarchically lowest level.

According to this arrangement, the information of the additional menu option is defined by a corresponding one of the menu tables for defining three kinds of menus, that is, the root menu, the lower level menu-designating menu, and the candidate menu, respectively, and an image element at a hierarchically lowest level can be searched based on the root menu. Therefore, after reception of the additional menu data, the additional menu option can be easily displayed by searching the image element at the lowest level in hierarchy based on the root menu.

Preferably, the additional menu option comprises at least one of menu options of an illustration, a symbol, a frame, and a guide symbol.

According to this arrangement, at least one of the menu options of an illustration, a symbol, a frame, and a guide symbol is included in the additional menu option, so that after reception of the additional menu data, any of illustrations, symbols, frames, or guide symbols classified into the added menu option can be selected for use as an image element.

Preferably, the printing apparatus further comprises position-designating means for designating a position in the print image for arranging the selected image element.

According to this arrangement, it is possible to form a print image by designating a position in the print image for arranging a selected image element.

According to a second aspect of this invention, there is provided a printing system comprising the printing apparatus as set forth above, and a supply device for transmitting the additional menu data to said printing apparatus as said other end of communication.

According to this printing system, the printing apparatus and the supply device for transmitting additional menu data to the printing apparatus as the other end of communication are arranged in the printing system, so that by changing additional menu data stored in the supply device or adding new data to additional menu data already stored in the supply device, it is possible to change additional menu data transmitted to the printing apparatus.

Preferably, the supply device comprises mounting means capable of mounting a storage medium storing the additional menu data and a program for transmitting the additional menu data to the printing apparatus, and program-executing means for executing the program stored in the mounted storage medium to transmit the additional menu data to the printing apparatus according to the program.

According to this arrangement, the supply device can mount therein a storage medium storing additional menu data and a program for transmitting the additional menu data to the printing apparatus, and transmit the additional menu data to the printing apparatus according to the program stored in the storage medium. Therefore, if only a storage medium of the above-mentioned kind, having various additional menu data stored therein, is mounted in the supply device, it is possible to add additional menus to the printing apparatus through execution of the program.

Preferably, the supply device comprises host communication means connected to another device via a predetermined network, for receiving the additional menu data from the another device.

According to this arrangement, the supply device is connected to the another device via the predetermined network such that it can receive additional menu data from the another device. Hence, the supply device receives various additional menu data to transmit the same to the printing apparatus, thereby enabling additional menu data stored in the printing apparatus to be changed.

According to a third aspect of the invention, there is provided a menu-adding method for a printing apparatus that forms a print image by arranging an image element selected from a displayed menu, in the print image. The menu-adding method comprises the steps of: receiving additional menu data from a predetermined other end of communication, the additional menu data including information of an additional menu option for being added to the displayed menu as a menu option thereof, and information of an image element displayed as an option hierarchically under the additional menu option; storing the additional menu data; and incorporating into the displayed menu the additional menu option and the image element hierarchically under the additional menu option, based on the additional menu data.

According to this menu-adding method, additional menu data including information of an additional menu option for being added to the displayed menu as a menu option thereof and information of image elements displayed as options hierarchically under the additional menu option is received from the predetermined other end of communication according to a predetermined communication protocol, and incorporated into the menu. This makes it possible to easily add a menu option and an image element made selectable via the menu option for use in forming a print image.

According to a fourth aspect of the invention, there is provided a storage medium for storing a program capable of executing functions of means of the printing apparatus as set forth above.

According to a fifth aspect of the invention, there is provided a storage medium for storing a program capable of executing the menu-adding method for the printing apparatus as set forth above.

According to these storage media, if the program stored in each of the storage media is read out and executed, it is possible to easily add a menu option and an image element made selectable via the menu option for use in forming a print image.

According to a sixth aspect of this invention, there is provided a printing apparatus for forming a print image by arranging an image element selected from a displayed menu, in the print image, comprising: a font data interface for receiving additional menu data from a predetermined other end of communication, the additional menu data including information of an additional menu option for being added to the displayed menu as a menu option thereof, and information of an image element displayed as an option hierarchically under the additional menu option; a control data area for storing the additional menu data; and a control block for incorporating into the displayed menu the additional menu option and the image element hierarchically under the additional menu option, based on the additional menu data.

According to a seventh aspect of this invention, there is provided a printing system comprising the printing apparatus according to the above-described sixth aspect of this invention, and a supply device for transmitting the additional menu data to said printing apparatus as the other end of communication.

According to an eighth aspect of this invention, there is provided a storage medium for storing a program capable of executing functions of constituting elements of the printing apparatus according to the above-described sixth aspect of this invention.

### BRIEF DESCRIPTION OF THE DRAWINGS

The above and other features and advantages of the invention will become more apparent from the following detailed description taken in conjunction with the accompanying drawings, wherein:

FIG. 1 is a diagram illustrating a first example of the configuration of a printing system incorporating a tape printing apparatus according to an embodiment of the invention;

FIG. 2 is a diagram similar to FIG. 1, which illustrates a second example of the configuration of the printing system;

FIG. 3 is a perspective view of the tape printing apparatus appearing in FIG. 1 or FIG. 2 with its lid open;

FIG. 4 is a block diagram showing the arrangement of the FIG. 3 tape printing apparatus;

FIG. 5 is a diagram showing an image representing a memory map of a ROM of the tape printing apparatus employed in the FIG. 2 second example of the configuration of the printing system, and an image representing a downloading process for downloading data from a personal computer;

FIG. 6 is a diagram illustrating the memory map of the ROM of the tape printing apparatus in more detail than in FIG. 5;

FIG. 7A is a diagram illustrating a data presence/absence table stored in an area of “data presence/absence” appearing in FIG. 6;

FIG. 7B a diagram showing a format of the FIG. 7A data presence/absence table;

FIG. 8 is a diagram showing contents of a font data address table shown in FIG. 6;

FIG. 9 is a diagram showing an example of the sizes of font data and memory capacities of areas for “SYMBOL”, “ILLUST”, and “FRAME” other than a menu option “G SYMBOL”;

FIG. 10 is a diagram showing an example of the sizes of font data and memory capacities of areas for the menu option “G SYMBOL”:

FIG. 11 is a diagram schematically showing the hierarchical relationship between menus of a menu table and menu table data associated therewith, appearing in FIG. 6;

FIG. 12 is a diagram illustrating an example of contents of a root menu table defining a root menu structure appearing in FIG. 11;

FIG. 13 is a diagram illustrating contents of a lower level menu-designating menu table defining a lower level menu-designating menu structure appearing in FIG. 11;

FIG. 14 is a diagram illustrating contents of a candidate menu table defining a candidate menu structure appearing in FIG. 11;

FIG. 15 is a flowchart showing a conceptual representation of an overall control process executed by the FIG. 3 tape printing apparatus;

FIG. 16 is a diagram showing an example of a sequence of screens displayed during a printing process executed by the FIG. 3 tape printing apparatus, which is useful in explaining a typical operating procedure for execution of the process;

FIG. 17 is a diagram showing an example of a sequence of screens displayed on the tape printing apparatus during a downloading process executed by the apparatus, which is useful in explaining a typical operating procedure for execution of the process;

FIGS. 18A to 18D are diagrams showing screens displayed on the tape printing apparatus during the FIG. 17 downloading process;

FIG. 19 is a diagram showing an example of a sequence of screens displayed on a personal computer incorporated in the FIG. 2 printing system, which is useful in explaining a typical operating procedure for execution of a process on the personal computer side corresponding to the FIG. 17 downloading process;

FIG. 20 is a diagram showing a communication sequence executed during the downloading process for downloading data from the FIG. 19 personal computer to the FIG. 17 tape printing apparatus;

FIGS. 21A to 21F are diagrams which are useful in explaining respective formats of examples of font data described with reference to FIG. 22 et seq.;

FIG. 22 is a diagram showing examples of font data of “ILLUST” classified into a business categorical menu option of “SHOP”;

FIG. 23 is a diagram showing examples of font data of “FRAME” classified into the business categorical menu option of “SHOP”;

FIG. 24 is a diagram showing examples of font data of “SYMBOL” classified into the business categorical menu option of “SHOP”;

FIGS. 25A and 25B are diagrams showing examples of a menu option of “ILLUST” displayed before and after the business categorical additional menu data is downloaded, respectively;

FIG. 26 is a diagram showing an example of a hierarchal display of options at levels under the menu option “ILLUST”, presented after the business categorical menu option of “SHOP” is downloaded;

FIG. 27 is a diagram showing examples of font data of “ILLUST” classified into a business categorical menu option of “CNSTRCTN”;

FIGS. 28A to 28C are diagrams showing examples of font data of “ILLUST” classified into respective business categorical menu options of “SCHOOL”, “HOSPITAL”, and “OTHERS”;

FIG. 29 is a diagram showing an example of a hierarchal display of options under the menu option “ILLUST”, presented after the business categorical menu option of “CNSTRCTN” is downloaded;

FIG. 30 is a diagram showing an example of a sequence of screens displayed in a manner associated with FIG. 29 menu structure when an image element under the menu option “ILLUST” is selected and arranged in a print image, which is useful in explaining a typical operating procedure therefor;

FIG. 31 is a diagram similar to FIG. 30 and continued from FIG. 30;

FIGS. 32A and 32B are diagrams showing examples of a menu option of “FRAME” displayed before and after business categorical additional menu data is downloaded, respectively;

FIG. 33 is a diagram showing an example of a hierarchal display of options at levels under the menu option “FRAME”, presented after the business categorical menu option of “SHOP” is downloaded;

FIG. 34 is a diagram showing examples of font data of “FRAME” classified into the business categorical menu option of “SCHOOL”;

FIGS. 35A to 35C are diagrams showing examples of font data of “FRAME” classified into the respective business categorical menu options of “CNSTRCTN”, “HOSPITAL”, and “OTHERS”;

FIG. 36 is a diagram showing an example of a hierarchal display of options at levels under the menu option “FRAME”, presented after the business categorical menu option of “SCHOOL” is downloaded;

FIG. 37 is a diagram showing an example of a sequence of screens displayed in a manner associated with the FIG. 36 menu structure when an image element under the menu option “FRAME” is selected and arranged in a print image, which is useful in explaining a typical operating procedure therefor;

FIG. 38 is a diagram similar to FIG. 37 and continued from FIG. 37;

FIG. 39 is a diagram showing examples of hierarchal display of options at levels under the menu option “SYMBOL”, presented after the business categorical menu option of “SHOP” and a menu option of “G SYMBOL” are downloaded;

FIG. 40 is a diagram showing examples of font data of “SYMBOL” classified into the business categorical menu option of “HOSPITAL”;

FIGS. 41A to 41C are diagrams showing examples of font data of “SYMBOL” classified into the respective business categorical menu options of “SCHOOL”, “CNSTRCTN”, and “OTHERS”;

FIG. 42 is a diagram showing an example of a hierarchal display of options at levels under the menu option “SYMBOL”, presented after the business categorical menu option of “HOSPITAL” is downloaded;

FIG. 43 is a diagram showing an example of a sequence of screens displayed in a manner associated with the FIG. 42 menu structure when an image element under the menu option of “SYMBOL” is selected and arranged in a print image, which is useful in explaining a typical operating procedure therefor;

FIG. 44 is a diagram showing examples of font data of “CULTURE” classified into the menu option of “G SYMBOL”;

FIGS. 45A to 45C are diagrams showing examples of font data of options of “PUBLIC”, “TRAFFIC” and “TRADE” classified into the menu option of “G SYMBOL”;

FIGS. 46A to 46D are diagrams showing examples of font data of “SAFTEY”, “PROHIBIT”, “CAUTION” and “INSTRUCT” classified into the menu option of “G SYMBOL”;

FIG. 47 is a diagram showing, by taking “CULTURE” as an example, a hierarchal display of options at levels under the menu option “SYMBOL”, presented after the menu option of “G SYMBOL” is downloaded; and

FIG. 48 is a diagram showing an example of a sequence of screens displayed in a manner associated with the FIG. 47 menu structure when an image element under the menu option of “G SYMBOL” is selected and arranged in a print image, which is useful in explaining a typical operating procedure therefor.

### DESCRIPTION OF THE PREFERRED EMBODIMENT

The invention will now be described in detail with reference to the drawings showing a tape printing apparatus according to an embodiment of the invention.

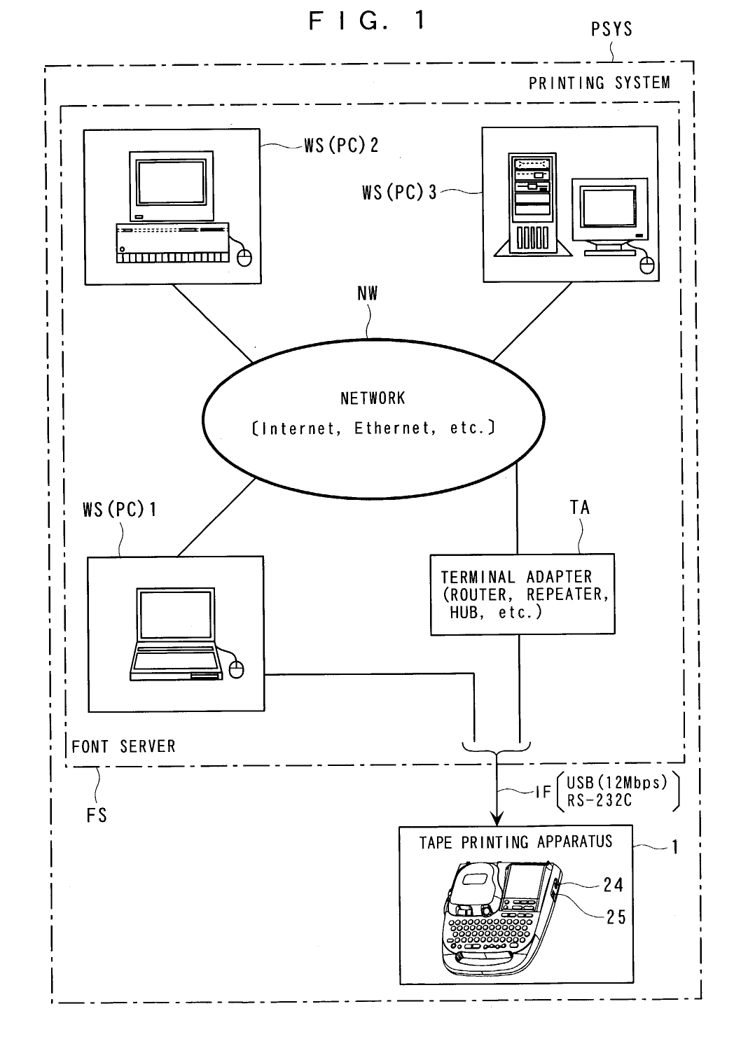

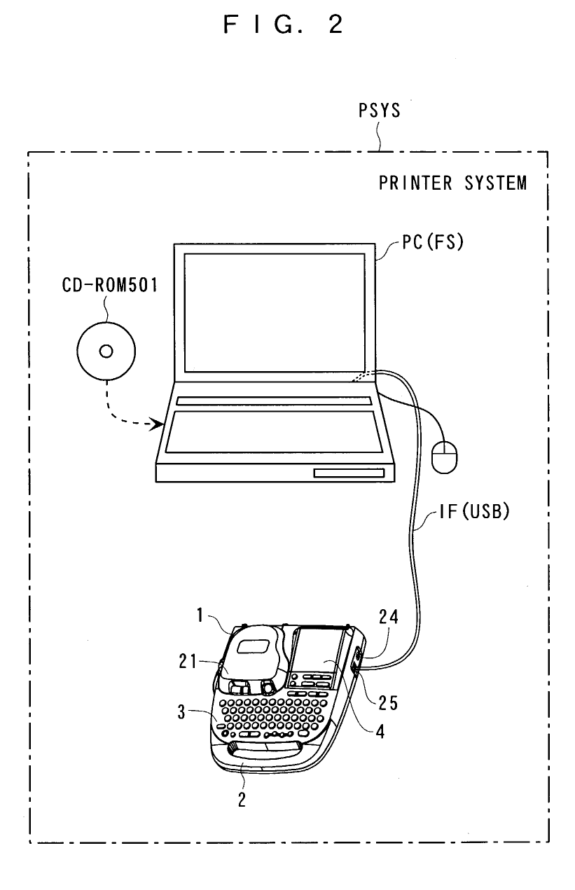

Referring first to FIGS. 1 and 2, the tape printing apparatus 1 according to the present embodiment is connected to a font server (supply device) FS via an interface IF to form a printing system PSYS as a whole. The font server FS is used for supplying additional menu data, referred to hereinafter, to the tape printing apparatus 1.

To this end, e.g., as shown in FIG. 1, the font server FS may be configured such that a plurality of work stations WSs (personal computers PCs, etc.) 1 to 3 which serve as terminals, and a terminal adapter TA and the like (including a rooter, a repeater, a hub, and so forth), are connected to each other via a network NW and any of the terminals may be connected to the tape printing apparatus 1 via the interface IF. In this case, as the network NW can be employed networks which enable communication in conformity to an IEEE standard LAN-based communication protocol, such as the so-called Internet, various types of local area networks (LANs: Ethernet (registered trademark), 10/100 Base, etc.). Further, the interface IF can be implemented by either serial data communication means (RS-232C, USB, IEEE1394, etc.) or parallel data communication means (Centronics, etc.). Although the above communication means is implemented based on cable transmission standards, it is also possible to utilize wireless transmission means as the interface.

Alternatively, the font server FS may be configured to have a simpler construction, i.e. formed as a standalone apparatus. For instance, as shown in FIG. 2, the printing system PSYS can be constructed simply by connecting a standalone personal computer PC and the tape printing apparatus 1 to each other via the interface IF, such as the USB or the like. It should be noted that according to the configuration shown in FIG. 1, additional menu data stored in the respective devices (WSs 1 to 3 and the like) in the font server FS is downloaded, while according to the configuration shown in FIG. 2, additional menu data stored, e.g., in the personal computer PC (font server FS) is downloaded. Of course, in the above cases, it is also possible to supply additional menu data from outside by using a compact disc (CD, CD-ROM) 501, for instance.

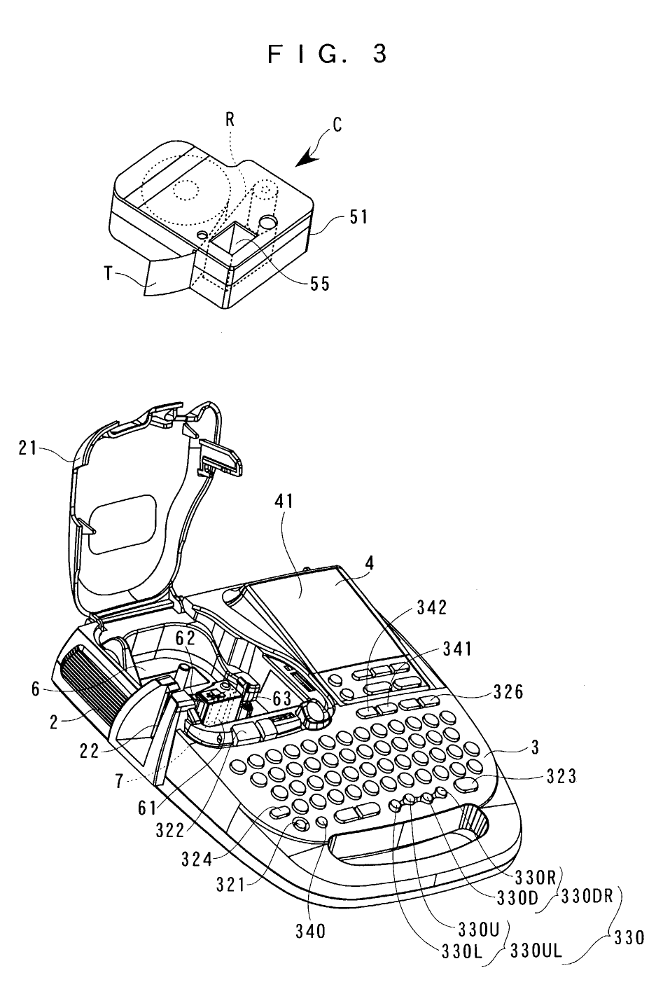

In the following, the FIG. 2 printing system PSYS relatively simple in construction will be mainly described. Referring now to FIG. 3, the tape printing apparatus 1 includes a casing 2 forming an outer shell thereof, which has a keyboard 3 comprised of various kinds of entry keys and arranged on the top of a front portion thereof. Further, the casing 2 has a lid 21 and a display 4 arranged on the left-hand side and the right-hand side of the top of a rear portion thereof, respectively.

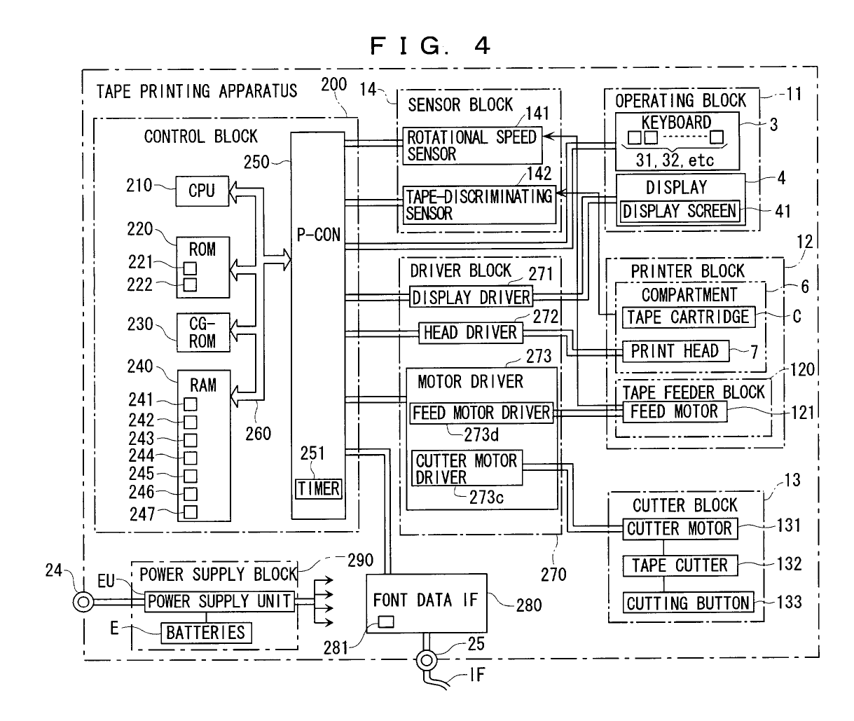

Further, as shown in FIG. 4, the tape printing apparatus 1 is basically comprised of an operating block 11 having the keyboard 3 and the display 4 for interfacing with the user, a printer block 12 having a print head (thermal head) 7 and a tape feeder block 120 for printing on a printing tape (hereinafter simply referred to as “the tape”) T unwound from a tape cartridge C mounted in a compartment 6, a cutter block 13 for cutting off a printed portion of the tape T, a sensor block 14 having various sensors for carrying out various detecting operations, a driving block 270 having drivers for driving circuits of devices of the apparatus 1, a font data interface (font data IF) 280 for communication with the font server FS via a USB connector 25 through the interface IF (formed by a USB cable), a power supply block 290, and a control block 200 for controlling operations of blocks and devices of the apparatus 1.

To implement the above construction, the casing 2 accommodates not only the above-mentioned blocks including the printer block 12, the cutter block 13, and the sensor block 14, but also a circuit board, not shown. On the circuit board are mounted the power supply block 290 as well as the circuits of the font data IF 280, the driving block 270, the control block 200, etc. The power supply block 290 has a power supply unit EU connected to a connector port 24 for connecting an AC adapter thereto, and batteries E, such as nicad batteries, which can be removably mounted within the casing 2 from outside, for supplying power to the components of the tape printing apparatus 1. The font data IF 280 has a receiving buffer 281 for receiving data (additional menu data: downloaded data) from the font server FS.

In the tape printing apparatus 1, after mounting the tape cartridge C in the compartment 6, the user enters printing information, such as desired characters (characters, numerals, symbols, simple figures, etc.) via the keyboard 3, while confirming or viewing the results of the entry or edit of the printing information on the display 4. Thereafter, when the user instructs the apparatus 1 to perform a printing operation via the keyboard 3, the tape feeder block 120 unwinds the tape T from the tape cartridge C, and the print head 7 prints on the tape T as desired. The printed portion of the tape T is delivered from a tape exit 22 as the printing proceeds. When the printing is completed as desired, the tape feeder block 120 further advances the tape T until an end of a tape length (the length of a label to be formed) including the length of margins comes to a cutting position, and then stops the feeding of the tape.

As shown in FIGS. 3 and 4, the printer block 12 has the compartment 6 arranged under the lid 21, for mounting the tape cartridge C therein. The tape cartridge C is mounted in or removed from the compartment 6 when the lid 21 is open. The tape cartridge C has a cartridge casing 51 holding a tape T having a predetermined width (within a range of approximately 4.5 to 48 mm) and an ink ribbon R. The tape cartridge C is formed with a through hole 55 for receiving therein a head unit 61 arranged in the compartment 6. Further, the tape cartridge C has a plurality of small holes formed in the bottom thereof for discrimination of the type of the tape T contained therein from the other types of the tape T having different widths, which are contained in other types of tape cartridges C. The compartment 6 has a tape-discriminating sensor 142 comprised of micro-switches or the like, for detecting the above holes to thereby determine the type of the tape T set for use.

The tape T has an adhesive surface formed on the reverse side thereof, with a peel-off paper layer covering the adhesive surface. The tape T and the ink ribbon R are fed such that they pass by the through hole 55, in a state overlaid upon each other, and the tape T alone is delivered out of the tape cartridge C, but the ink ribbon R is taken up into a roll within the tape cartridge C.

The head unit 61 contains the print head 7 formed by a thermal head. The print head 7 is brought into contact with the reverse side of the ink ribbon R exposed to the through hole 55 of the tape cartridge C when the tape cartridge C is mounted in the compartment 6 with the print head 7 fitted in the through hole 55. Then, by driving the print head 7 while heating the same, desired characters and the like are printed on the surface of the tape T. Further, the casing 2 has a left side portion thereof formed with the tape exit 22 for communication between the compartment 6 and the outside of the apparatus. Opposed to the tape exit 22, there is arranged a tape cutter 132 for cutting off a delivered or dispensed portion of the tape T.

Further, the compartment 6 is provided with drive shafts 62, 63 for engagement with driven portions of the tape cartridge 4 mounted in the compartment 6. A feed motor 121 as a drive source drives these drive shafts 62, 63 for rotation to feed or advance the tape T and the ink ribbon R in the tape cartridge C, and at the same time the print head 7 is driven in synchronism with the feeding of the tape and ribbon to carry out printing. Further, after completion of the printing operation, the tape T continues to be fed to bring a predetermined cutting position (corresponding to the tape length) on the tape T to the position of the tape cutter 132.

It should be noted that the feed motor 121 has an end on which is rigidly fitted a disc, not shown, formed with detection openings, and a rotational speed sensor 141 comprised of a photo sensor or the like is arranged to face the path of the detection openings of the disc, for sending information of the rotational speed of the feed motor 121 detected thereby to the control block 200.

The cutter block 13 includes a tape cutter 132, a cutting button 133 for being manually operated to cause the tape cutter 132 to cut the tape T, e.g., in the case of a desired length printing, and a cutter motor 131 for automatically driving the tape cutter 132 to cut the tape T, e.g., in the case of a fixed length printing. To selectively carry out one of the two cutting operations, the tape printing apparatus 1 can be switched between a manual cutting mode and an automatic cutting mode by a mode-setting operation. Therefore, in the manual cutting mode, when the printing operation is completed, the user pushes the cutting button 133 arranged on the casing 2, whereby the tape cutter 132 is actuated to cut the tape T to a desired length. On the other hand, in the automatic cutting mode, after completion of the printing operation, the tape T is sent further by the length of a rear margin, and then stopped, whereupon the cutter motor 131 is driven to cut off the tape T. It should be noted that the tape printing apparatus may be configured to perform only one of manual cutting and automatic cutting to suit the actual requirements of the tape printing apparatus.

The sensor block 14 includes the rotational speed sensor 141, and the tape-discriminating sensor 142. It should be noted that these sensors can be omitted to suit the actual requirements of the tape printing apparatus.

The driving block 270 includes a display driver 271, a head driver 272, and a motor driver 273. The display driver 271 drives the display 4 of the operating block 11 in response to control signals delivered from the control block 200, i.e. in accordance with commands carried by the signals. Similarly, the head driver 272 drives the print head 7 of the printer block 12 in accordance with commands from the control block 200. Further, the motor driver 273 includes a feed motor driver 273d for driving the feed motor 121 of the printer block 12, and a cutter motor driver 273c for driving the cutter motor 131 of the cutter block 13, and similarly to the display driver 271 and the head driver 272, drives each motor in accordance with commands from the control block 200.

The operating block 11 includes the keyboard 3 and the display 4. The display 4 has a display screen 41 which is capable of displaying display image data of eighteen characters per line on a rectangular display area of approximately 6 cm in the horizontal direction (X direction)×4 cm in the vertical direction (Y direction). The display 4 is used by the user when he enters data via the keyboard 3 to form or edit print image data, such as character string image data, and view a result of the entry, or enters instructions or commands via the keyboard 3.

On the keyboard 3, there are arranged a character key group 31 including an alphabet key group, not shown, a symbol key group, not shown, a number key group, not shown, and a nonstandard character key group not shown, for calling nonstandard characters for selection, as well as a function key group 32 for designating various operation modes and the like. In a type of the apparatus 1 (Japanese language-adapted type) which is capable of entering the Japanese language, there is also provided a kana key group, not shown, for entering Japanese hiragana letters and Japanese katakana letters.

The function key group 32 includes a power key 321, not shown, a print key 322 for instructing a printing operation, a selection key 332 for finally determining entry of character data and starting new lines during text entry as well as determining selection of one of the various operating modes on each of selection screens, a shift key 324, a delete key which is capable of deleting entered characters, and at the same time instructing deletion of a whole sentence, and a cancel key 326 for canceling instructions.

The function key group 32 also includes four cursor keys 330 (330U (up arrow key), 330D (down arrow key), 330L (left arrow key), 330R (right arrow key)) for moving the cursor or the display range of display image data on the display screen 41 in respective upward, downward, leftward, and rightward directions. (In FIG. 17 et. seq., the down arrow key 330D and the right arrow key 330R are collectively referred to as the “cursor key 330DR” which is represented in the figures as a box containing a black triangle pointing in a downward and rightward direction. Similarly, the up arrow key 330U and the left arrow key 330L are collectively referred to as the “cursor key 330UL” which is represented in the figures as a box containing a black triangle pointing in a upward and leftward direction.)

The function key group 32 further includes an environment-setting key 340, referred to hereinafter, for setting up an environment, a symbol key 341 for selecting (entering) symbols, and a style key 342 for selecting (setting) a style, such as a character size, layout, and a frame. Of course, similarly to keyboards of the general type, the above-mentioned key entries may be made by the respective keys exclusively provided therefor or by a smaller number of keys operated in combination with the shift key 324 and/or the like.

As shown in FIG. 4, from the keyboard 3, various commands and data described above are input to the control block 200.

The control block 200 includes a CPU 210, a ROM 220, a character generator ROM (CG-ROM) 230, a RAM 240, and a peripheral control circuit (P-CON) 250, all of which are connected to each other by an internal bus 260.

The ROM 220 formed by a rewritable flash ROM has a control program area 221 for storing control programs executed by the CPU 210 and a control data area 222 for storing control data including additional menu data (download data), referred to hereinafter, in addition to a color conversion table and a letter modification table.

The CG-ROM 230 stores font data (either outline font or bit map data may be stored by taking memory capacity or the like into consideration) of pictographs, symbols, figures and the like, provided for the tape printing apparatus 1. When code data for identifying a character or the like is input thereto, it outputs font data corresponding to the code data.

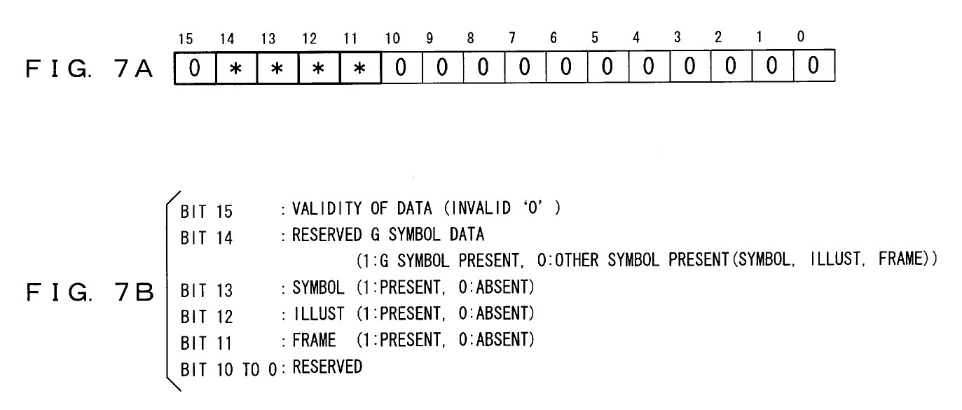

The RAM 240 is supplied with power by a backup circuit, not shown, such that stored data can be preserved even after the power is turned off by operating the power key 321. The RAM 240 includes areas of a register group 241, a text data area 242 for storing text data of characters or the like input by the user via the keyboard 3, a display image data area 243 for storing image data displayed on the display screen 41, a print image data area 244 for storing print image data, a registered image data area 245 for storing registered image data, as well as a data presence/absence table area 246 for storing (a copy of, see FIGS. 7A and 7B,) a data presence/absence table including a data validity flag (Valid_Flag) VF, referred to hereinafter, buffer areas 247, and so forth. The RAM 240 is used as a work area for carrying out the control process.

The P-CON 250 incorporates a logic circuit for complementing the functions of the CPU 210 as well as dealing with interface signals for interfacing between the CPU 210 and peripheral circuits. The logic circuit is comprised of gate arrays, and custom LSI's. The P-CON 250 also incorporates the function of a timer 251 for measuring elapsed time.

To perform its functions, the P-CON 250 is connected to the sensors of the sensor block 14 and the keyboard 3, for receiving the above-mentioned signals generated by the sensor block 14 as well as commands and data entered via the keyboard 3, and inputting these to the internal bus 260 directly or after processing them. At the same time, the P-CON 250 is connected to the font data IF 280, for receiving control signals and (download) data from the font server FS, and inputting these to the internal bus 260 directly or after processing them. Further, the P-CON 250 cooperates with the CPU 210 to deliver data and control signals input to the internal bus 260 by the CPU 210 or the like, to the driving block 270 and the font data IF 280 directly or after processing them.

The CPU 210 of the control block 200 receives the signals, the commands, and data via the P-CON 250, according to the control program read from the ROM 220, processes font data from the CG-ROM 230 and various data stored in the RAM 240, and delivers control signals to the blocks and devices of the apparatus 1 via the P-CON 250 to thereby carry out position control during printing operations, and display control of the display screen 41, as well as control of the print head 7 to carry out printing on the tape T under predetermined printing conditions. In short, the CPU 210 controls the overall operation of the tape printing apparatus 1.

In the present embodiment, it is possible to easily add menu options for use in selecting image elements forming a print image and image data of the image elements which can be selected from the menu options. In the following, the method of adding the menu options and the image data of the image elements will be described in detail.

In the description, the printing system configured as shown in FIG. 2 is mainly employed as the printing system PSYS, and (graphic) images classified into symbols (pictographs), illustrations, frames, and so forth are described by way of examples of the image elements to be added. Further, the description is given of an example in which image data (bitmap font data) of the image elements, and data for adding menu options for selecting the image elements are collectively downloaded as additional menu data (download data).

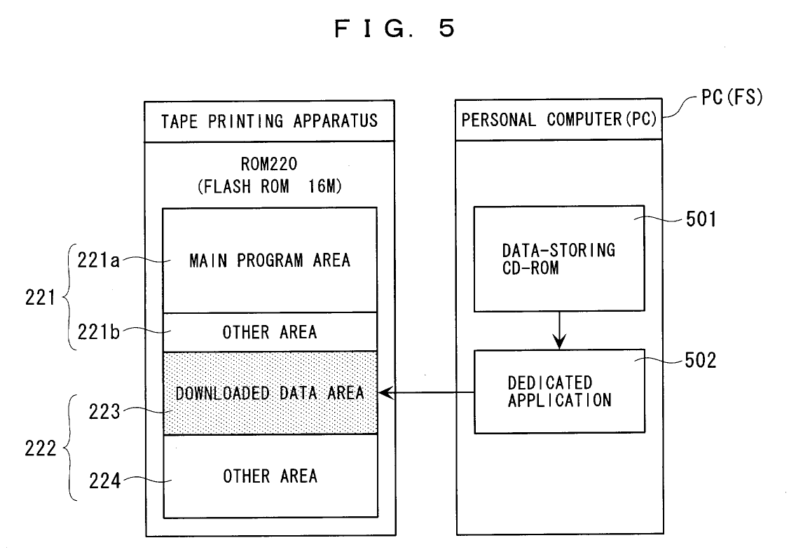

First, the ROM 220 described above with reference to FIG. 4 is formed by a rewritable flash ROM (16-Mbyte ROM is assumed in this embodiment). As shown in FIG. 5, the ROM 220 is configured, as a memory map image, such that the control program area 221 is divided into a main program area 221a and the other area 221b, and similarly, the control data area 222 is divided into a downloaded data area 223 (area of 128 Kbytes is assumed in this embodiment) and the other area. On the other hand, in the personal computer PC (i.e. the font server FS) described above with reference to FIG. 2, for instance, the CD-ROM 501 having additional menu data stored therein is mounted (inserted), and a dedicated application 502 exclusively provided for the download (by the tape printing apparatus 1) of the additional menu data (download data) is started to allow the data to be downloaded into the downloaded data area 223 of the tape printing apparatus 1.

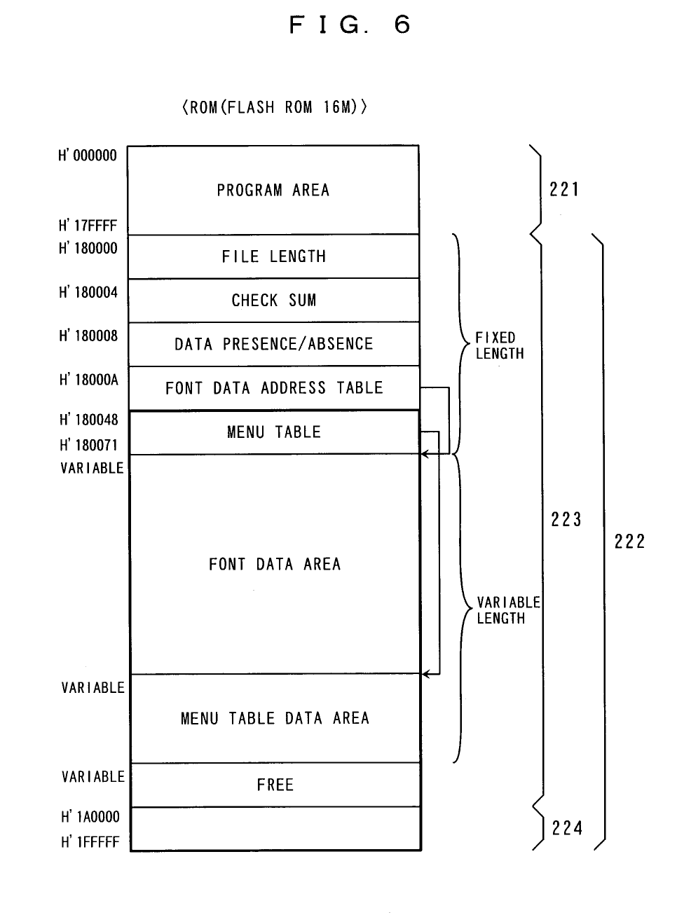

In this embodiment, the details of the additional menu data, and the memory map formed after the completion of the downloading are as shown in FIG. 6. In the figure, 128 Kbytes between a Hexadecimal [180000] (hereinafter referred to as “H[180000]” by adding an initial letter of the letter string “Hexadecimal” to the brackets [ ]; In FIG. 6 et. seq., the brackets [ ] are omitted and shown as “H′180000”) and H[19FFFF] is assigned to an area of the additional menu data (download data), that is, the downloaded data area 223.

In the memory map, “file length” indicates an area (4-byte area of H[180000] to [180003]) storing information of data length (128 K at the maximum) of whole data downloaded from the personal computer PC. “Check sum” indicates an area (4-byte area of H[180004] to [180007]) for storing information of the check sum of the whole data. The check sum is used for checking the downloaded data by the dedicated application 502.

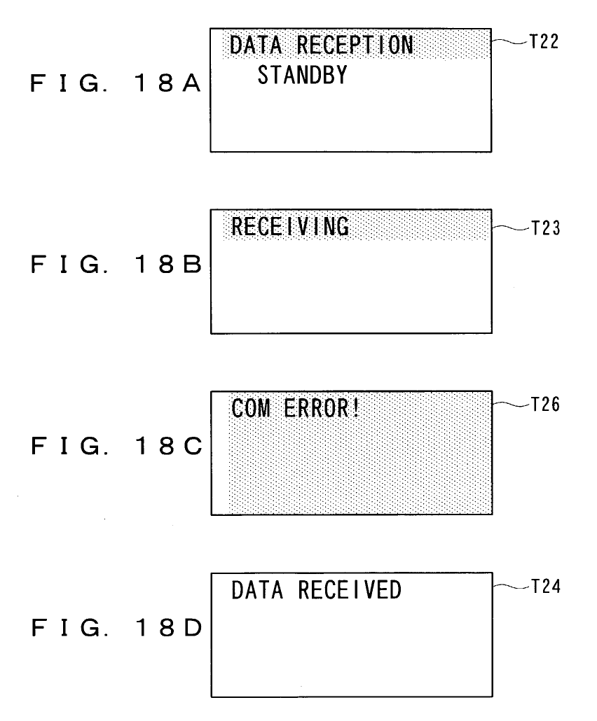

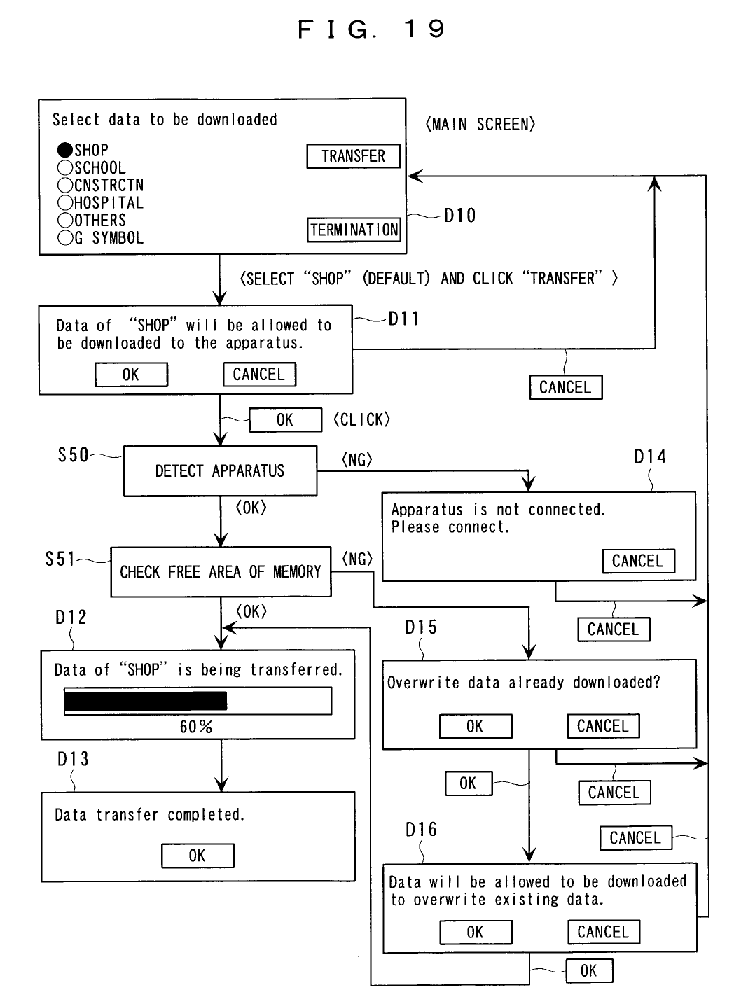

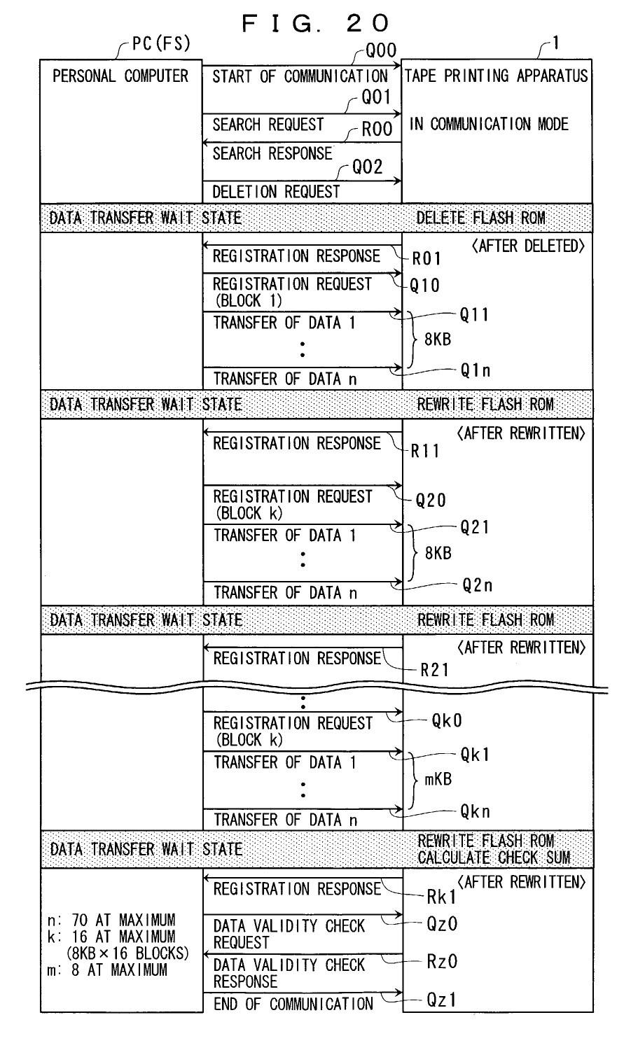

Further, “presence/absence of data” indicates an area (2-byte area of H[180008] to [180009]) for a table (data presence/absence table) having a format shown in FIGS. 7A and 7B, which is used in determining validity of data. Since an area (data presence/absence table area) 246 for storing the data presence/absence table is provided in the RAM 240, Bit 15 (most significant bit) of the data presence/absence table in the data presence/absence table area 246 is defined as the “Valid_Flag VF”. The Valid_Flag VF is set to “0” (validity of data is reset) in a downloading process, referred to hereinafter (see FIG. 20), before the data of the downloaded data area 223 of the ROM (flash ROM) 220 is deleted immediately before rewriting of same (for downloading of new data).

Further, after the downloading of new data has been terminated, i.e. after the rewriting of the downloaded data area 223 has been terminated, and before the downloaded data is checked by using the check sum, the data presence/absence table in the downloaded data area 223 is copied in the data presence/absence table area 246. If a result of the checking is “OK”, the Valid_Flag VF is set to “1” (VF←1: validity of data is set), whereas if the result of the checking is “NG”, the Valid_Flag VF is set to “0” (VF←0: validity of data is reset). Hereinafter, when validity of data is determined at the start of the next downloading process or the like, the Valid_Flag VF is made use of.

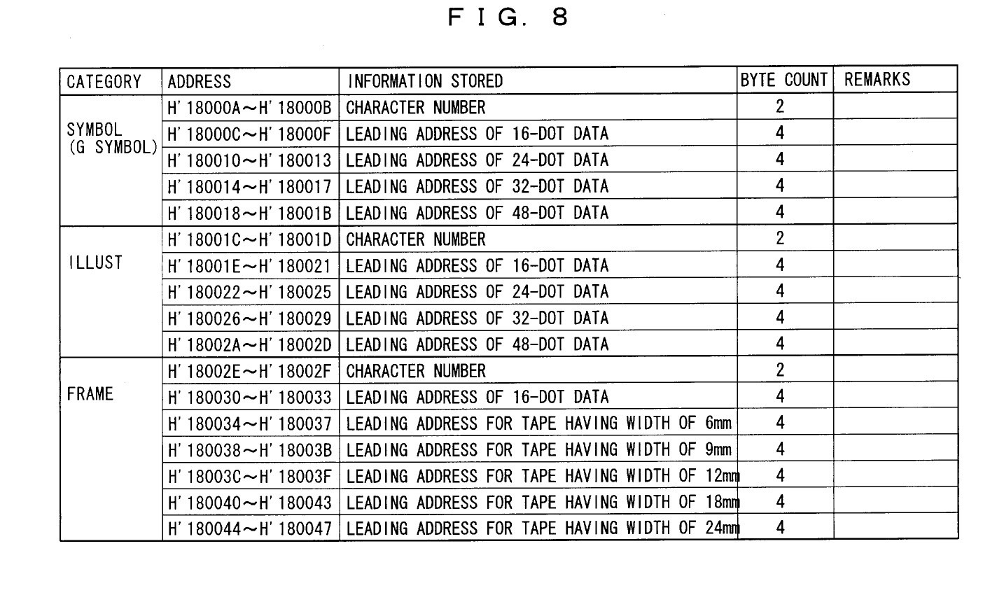

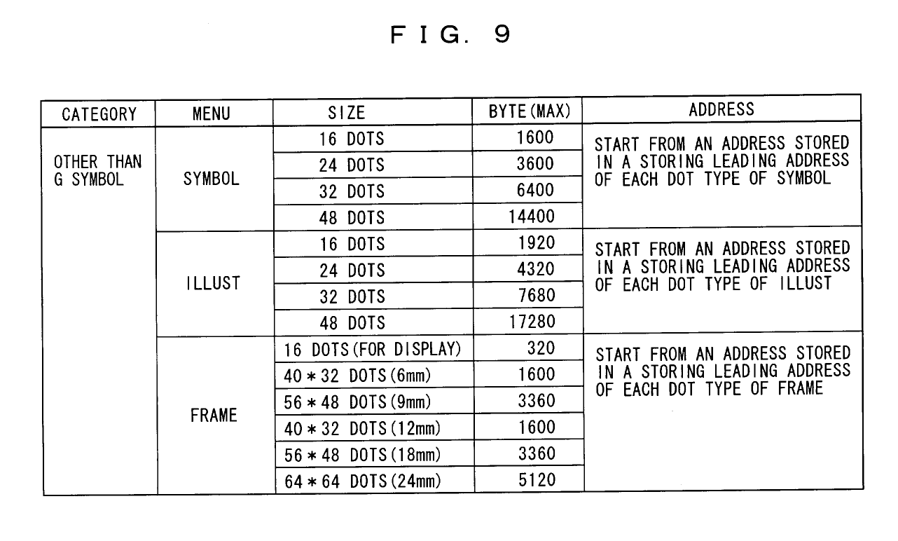

“Font data address table” in FIG. 6 indicates an area (H[18000A] to [180047]) storing contents, shown in FIG. 8, which define the number of characters downloaded (the number of data), and leading addresses of font data of “SYMBOL” (or “G SYMBOL”), “ILLUST” (illustration), and “FRAME”. For instance, when the number of characters for “SYMBOL” is thirty, thirty font data items of 16 dots are provided, and similarly, thirty data items are provided for respective font data of other dots (24 dots, 32 dots, 48 dots). The font data items are stored in storage areas allocated thereto according to the dot font types of 16-dot font, 24-dot font, 32-dot font, 48-dot font (see FIG. 9).

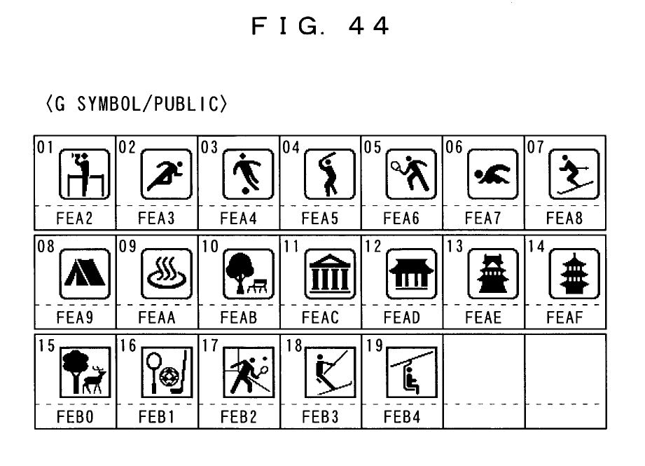

It should be noted that in the above description, the term “guide symbol” is used to mean a so-called “public information symbols” (“symbols”, particularly for public information purposes, developed by Foundation for Promoting Personal Mobility and Ecological Transportation in Japan: see FIGS. 44 to 46D). In the present embodiment, it is assumed that when data of the menu option “G SYMBOL” is to be downloaded, only the data of “G SYMBOL” is downloaded (see FIG. 10) without downloading data of “ILLUST” or “FRAME”.

“Menu table” and “menu table data” in FIG. 6 indicate areas for storing data of menu tables defining menus at a plurality of hierarchical levels. The menu tables are classified into type 0 to type 2 defining the respective structures (formats) of the menus. The type 0 has a root menu structure, the type 1 has a candidate menu structure (final menu: at a level hierarchically immediately above font data since a candidate font data is designated for selection at this level), and the type 2 has a lower level menu-designating menu structure (for designating a menu positioned at a hierarchically lower level).

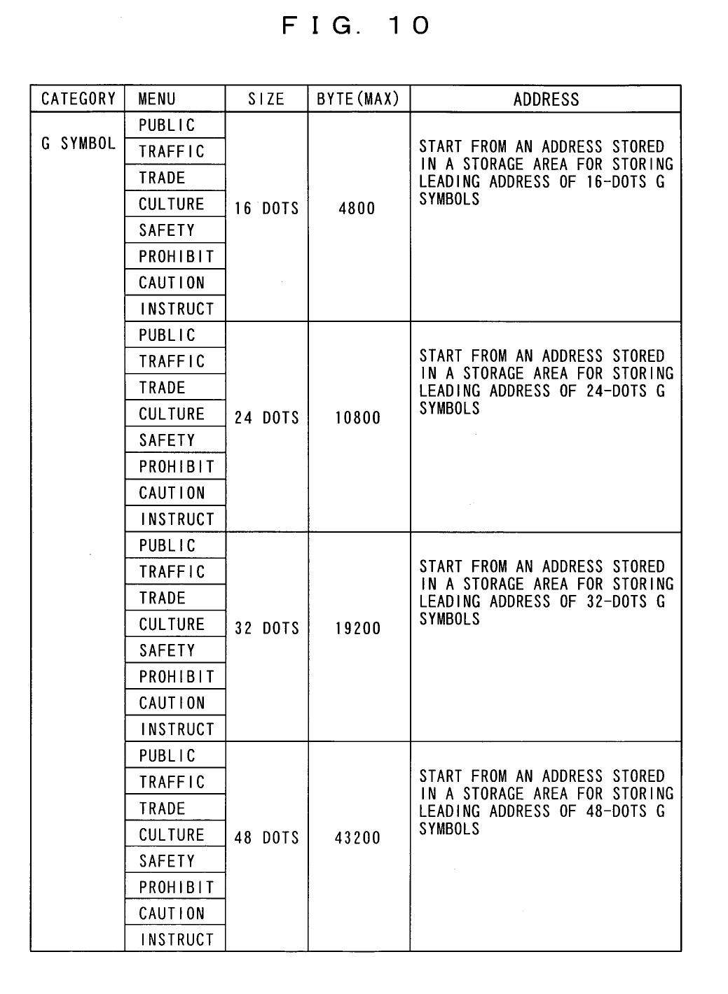

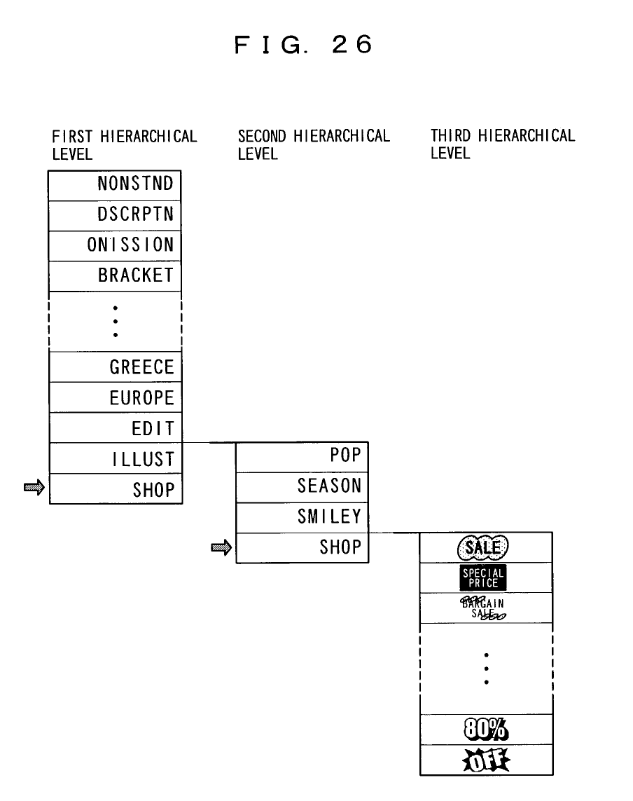

The root menu of the type 0 has a structure (root menu structure) shown in FIGS. 11 and 12. The menu options in the root menu each have 14 bytes assigned thereto. Out of the first two of the 14 bytes, the more significant one byte (8 bits) is used for indicating a type (type=0 in this case), and the less significant one byte (8 bits) is used for indicating the number of candidates (candidate count). The next 8 bytes are used for indicating the name of the menu option (menu option name) to be shown in the menu. The 8 bytes provide an area for displaying eight characters in accordance with a character code which represents one character by one byte (in the case of the Japanese language adapted type, four characters in accordance with a shift JIS code which represents one character by two bytes), as shown, e.g., in FIG. 26, etc. It should be noted that in the event of the number of characters to be displayed being smaller than eight, a code of a blank (space) is inserted. Further, the last four bytes define the address of a menu indicated by the present menu option and displaying the candidates at a hierarchically lower level. Here, an address of H[000000] shows that there is no menu at the hierarchically lower level. Further, when a table positioned at the hierarchically lower level is of the type 1 (candidate menu), the “candidate count” literally indicates the number of candidates of font data, whereas when the table at the hierarchically lower level is of the type 2 (lower level menu-designating menu), the “candidate count” indicates the number of menu options (the number of menus each comprised of 14 bytes) linked thereto.

In the present embodiment, since the three menu options, such as “SYMBOL” (or “G SYMBOL”), “ILLUST”, and “FRAME”, are provided as menu options of the root menu (the number of menu options as the root menus is three), an area of 14 bytes×3 items=42 bytes (H[180048] to [180071]) is allocated to the menu table data area, which is the last area ([180071] as a final address) of fixed length data areas in the memory map. However, as shown in FIG. 6, the start address of the font data area is configured to be variable and hence, e.g., when the number of menu options to be added as the root menus is equal to or larger than four, it is only required to allocate another area of 14 bytes for one menu option (the final address is H[18007F] when four menu options are provided).

The lower level menu-designating menu of the type 2 has a structure (lower level menu-designating menu structure) shown in FIGS. 11 and 13. Each menu option has 14 bytes assigned thereto. The basic structure of the menu option including contents defined in the associated table is the same as that of the root menu shown in FIG. 12, and it is only required to allocate an area of 14 bytes for each menu option displayed in this type of menu. In the present embodiment, as shown in FIGS. 6 and 11, the lower level menu-designating menus are stored in a menu table data area together with the candidate menus.

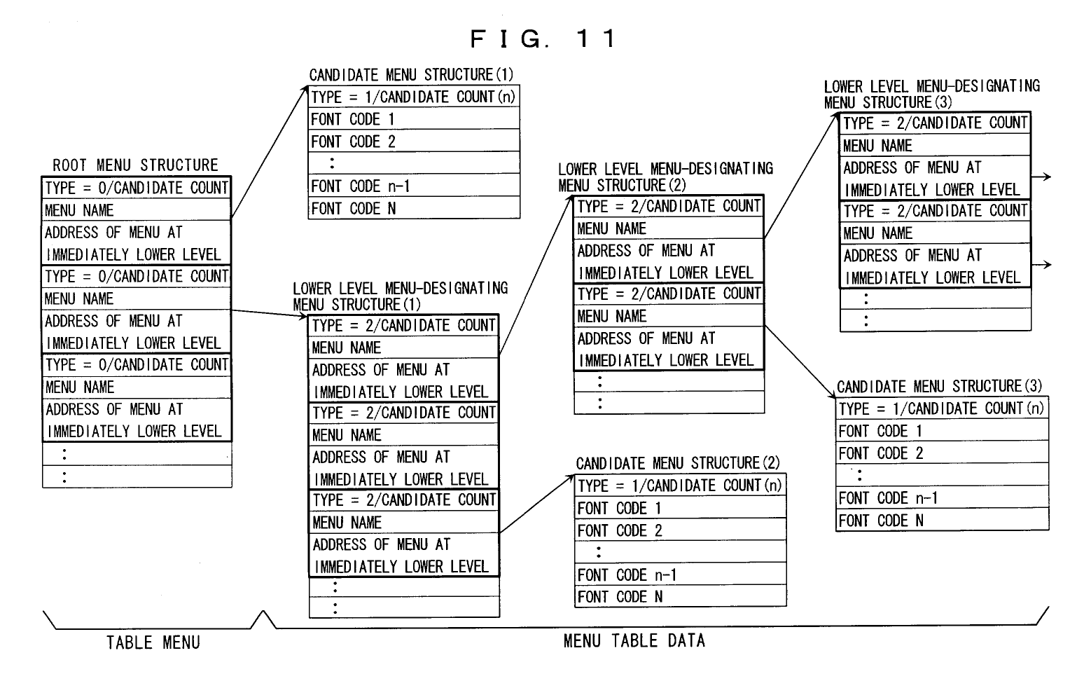

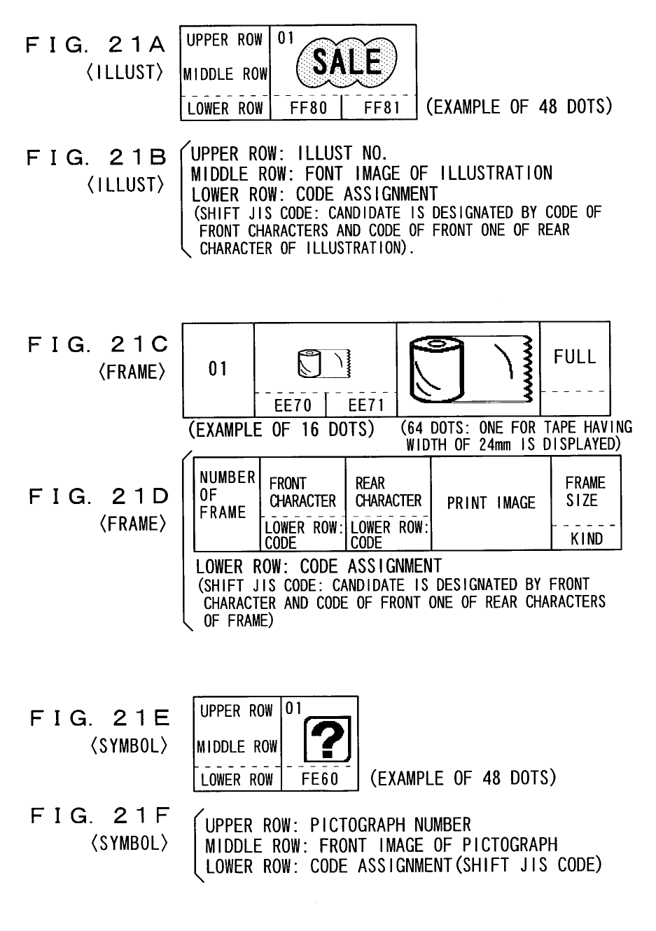

The candidate menu of the type 1 has a structure (candidate menu structure) shown in FIGS. 11 and 14, for designating n candidates indicated by the candidate count=n (n is an integer). In this case, each candidate is designated in accordance with the shift JIS code which defines one character by two bytes of code data (or a code equivalent to the shift JIS code) as shown in, e.g., FIGS. 21 to 24.

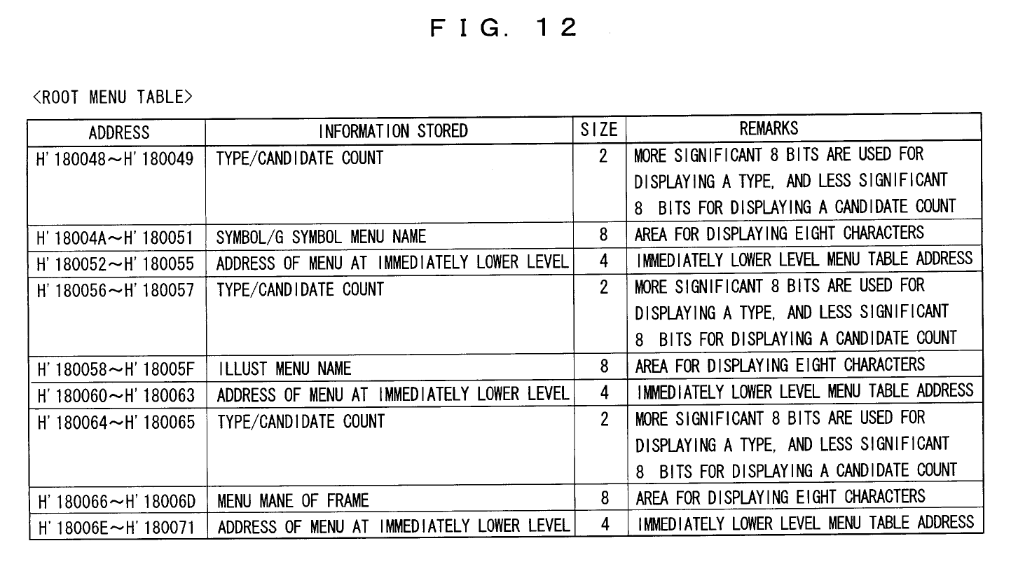

Next, the overall control process carried out by the tape printing apparatus 1 will be described with reference to FIG. 15. As shown in the figure, when the program for carrying out the control process is started, e.g., when the power key is depressed (the power of the tape printing apparatus 1 is turned on), first, in a step S1, initialization of the system including restoration of saved control flags is carried out to restore the tape printing apparatus 1 to the state it was in before the power was turned off the last time. Then, the image that was displayed on the display screen 41 before the power was turned off the last time is shown as the initial screen in a step S2. The following steps in the figure, that is, a step S3 for determining whether or not a key entry has been made and a step S4 for carrying out an interrupt handling operation are conceptual representation of actual operations. Actually, when the initial screen has been displayed in the step S2, the tape printing apparatus 1 enables an interrupt by key entry (keyboard interrupt), and maintains the key entry wait state (No to S3) until a keyboard interrupt is generated. When the keyboard interrupt is generated (Yes to S3), a corresponding interrupt handling routine is executed in the step S4, and after the interrupt handling routine is terminated, the key entry wait state is again enabled and maintained (No to S3).

As described above, in the tape printing apparatus 1, main processing operations by the apparatus are carried out by interrupt handling routines, and hence if print image data for printing is provided or has been prepared, the user can print the image data at a desired time, by depressing the print key 322 at the desired time and thereby generating a print interrupt to start a printing process, whereby the user can print a print image based on the print image data at the desired time. In short, the user can select any of possible operating procedures up to the printing operation as he desires.

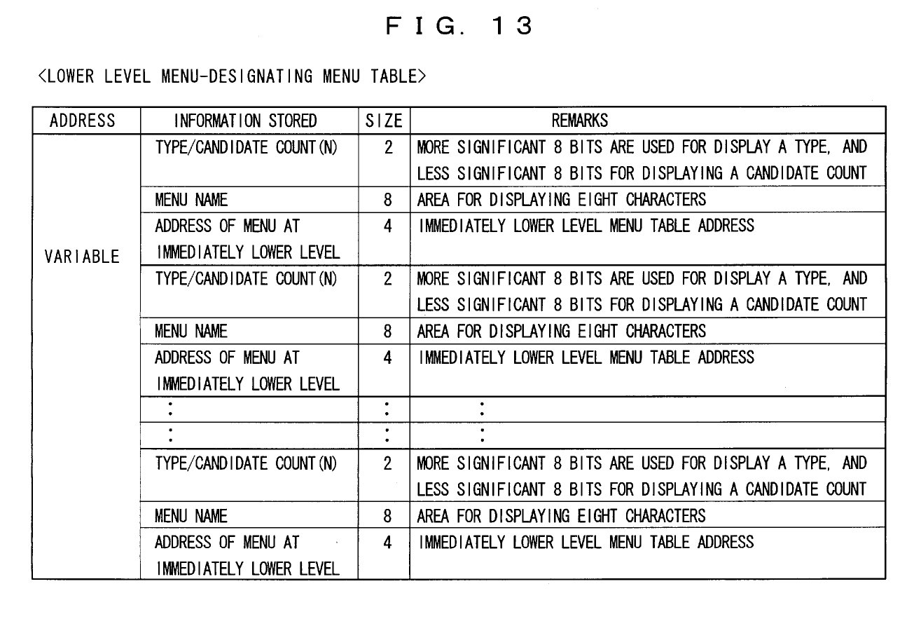

For instance, as shown in FIG. 16, if the print key 322 is depressed by the user when the text edit screen displays a letter (character) string “ABC” as a first line of the entry by the user (screen T10: hereinafter, contents displayed on the display screen 41 of the display 4 of the tape printing apparatus are referred to as the “screen T??” (? representing a numeral) and the reference numerals for the screens are shown only by T??), a message “PRINTING” is displayed, and at the same time the character string image of the character string “ABC” is printed as a print image (T11). After the printing has been completed, the screen returns to the text edit screen (T12: the same as T10).

It should be noted that a print image (print layout or a so-called print preview) can be displayed in an image area IG shown in the figure on the text edit screen, by configuring internal settings (for operation mode). Further, in the tape printing apparatus 1, the user can cancel instructions provided via the keyboard 3 by operating the cancel key 326. That is, the screen can be returned to the original text edit screen (T10) by depressing the cancel key 326 in the state of the display screen (T11) being displayed. The cancel key 326 similarly acts in all cases on the following screens unless otherwise specified, and hence description of this operation in respective states of the screens will be omitted hereinafter).

Next, a typical operating procedure for executing the downloading process described above with reference to FIG. 5, and internal processing executed according to the operating procedure, assuming that the FIG. 2 printing system is used, will be described hereinafter.

Referring to FIG. 17, first, in the tape printing apparatus 1, when the environment-setting key 340 is depressed (operated) by the user in the state of the text edit screen (T10: the same as T10 in FIG. 16) being displayed, a selection screen (T20) for setting an environment of the internal processing is displayed as shown in the figure. On the selection screen, menu options, such as “DATA RECEPTION” as well as “PRINT DENSITY”, “DISPLAY DENSITY”, “RESTORE DEFAULT”, “RESTORE VALUE”, and the like are displayed. The user can display a desired one of the menu options in reverse video by operating the cursor key 330 (T20, T21), and designate the menu option displayed in reverse video (hereinafter referred to as the “option highlighted for selection”) by depressing the selection key 323.

For instance, if the up arrow key 330U or the left arrow key 330L (cursor key 330UL) is depressed by the user in the state of the option “DISPLAY DENSITY” being highlighted for selection (T20), the option “PRINT DENSITY” is highlighted for selection. Inversely to the above assumption, if the down arrow key 330D or the right arrow key 330R (cursor key 330DR) is depressed, the option “RESTORE DEFAULT” is highlighted for selection. Thereafter, each time the cursor key 330DR is operated, the menu options “RESTORE VALUE” and “DATA RECEPTION” are highlighted for selection (T20, T21) accordingly.

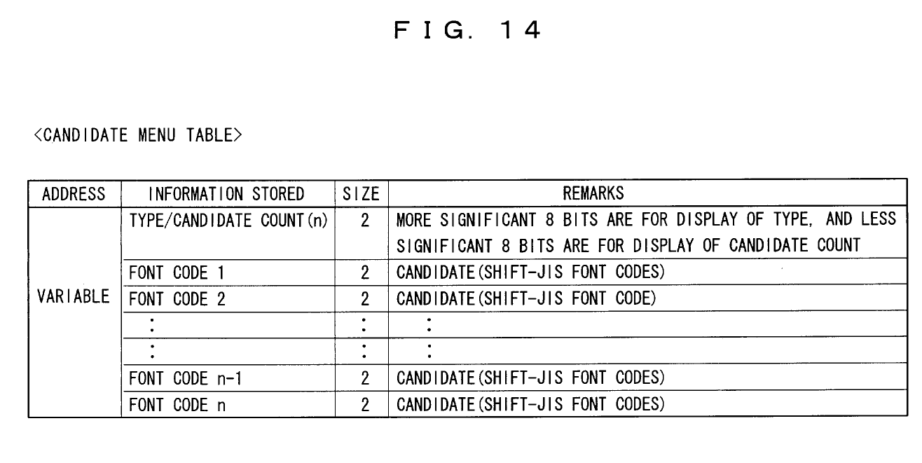

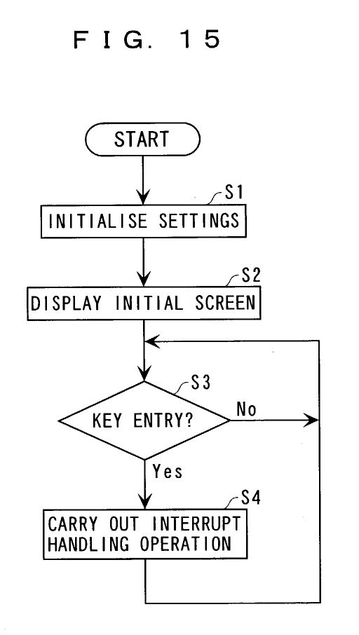

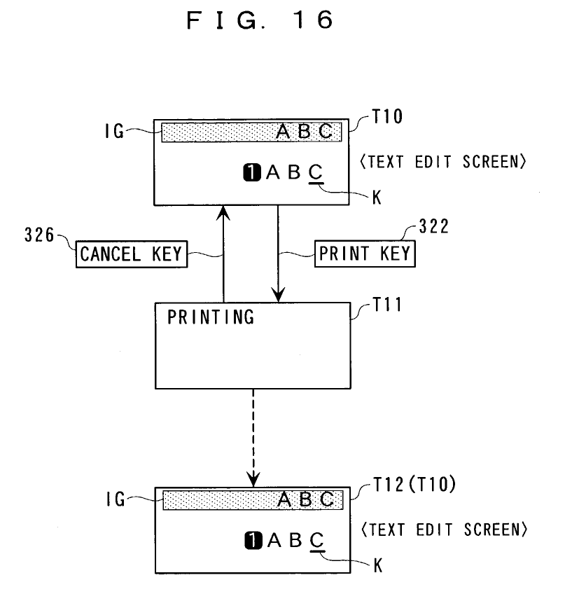

In this example, in order to carry out the downloading process, the user can highlight “DATA RECEPTION” for selection (T21) by operating the cursor key, and terminate the selection screen to switch the screen to a data reception wait or standby state (T22: see FIG. 18A) by depressing the selection key 323. In the standby state, even if a key other than the power key 321 and the cancel key 326 is operated, the key operation is disregarded (made invalid). Further, automatic power-off designated by default is also made invalid. In this example, when the power key 321 is depressed, the power is turned off, and when the power is turned on again, the screen returns to the text edit screen (T10) immediately before the power was turned off.

When the apparatus is in the above standby state (T22), it waits for operation, referred to hereinafter, of the personal computer PC (FS) and when data starts to be received, the apparatus is shifted to a data-receiving state for receiving data, and displays a message notifying the user of the fact on the display screen 41 (T23: see FIG. 18B). During reception of the data, all the key operations except for depression of the power key 321 are made invalid.

During reception of data, there can occur various errors, such as a “write error” generated in response to writing of data into the ROM 220, an error generated concerning the interface IF, e.g., in response to insertion or pull-out of the USB cable into or from the apparatus, a “timeout” which occurs when a communication request or response is made (see FIG. 20), and a “check sum error”. When any of the above errors has occurred, an error message “COM ERROR!” (short for “COMMUNICATION ERROR”) is uniformly displayed (T26: see FIG. 18C), and then the display screen is returned to the immediately preceding screen (T22) by any key hit.

After the reception of data has been terminated, a message “DATA RECEIVED” is displayed (T24: see FIG. 18D), and when the selection key 323 is depressed for confirmation by the user, the display screen is returned to the text edit screen (T25: the same as T10 in FIG. 16). It should be noted that the screen may be configured to automatically return to the text edit screen after the lapse of a predetermined time period without depression of the selection key 323. Further, as described above with reference to FIGS. 5 and 6, in the present embodiment provides, an area for 127 Kbytes is allocated to the downloaded data area 223, and hence the amount of data received is 128 Kbytes at the maximum. In this case, a time period required for transfer of the data is considered to be within approximately three minutes.

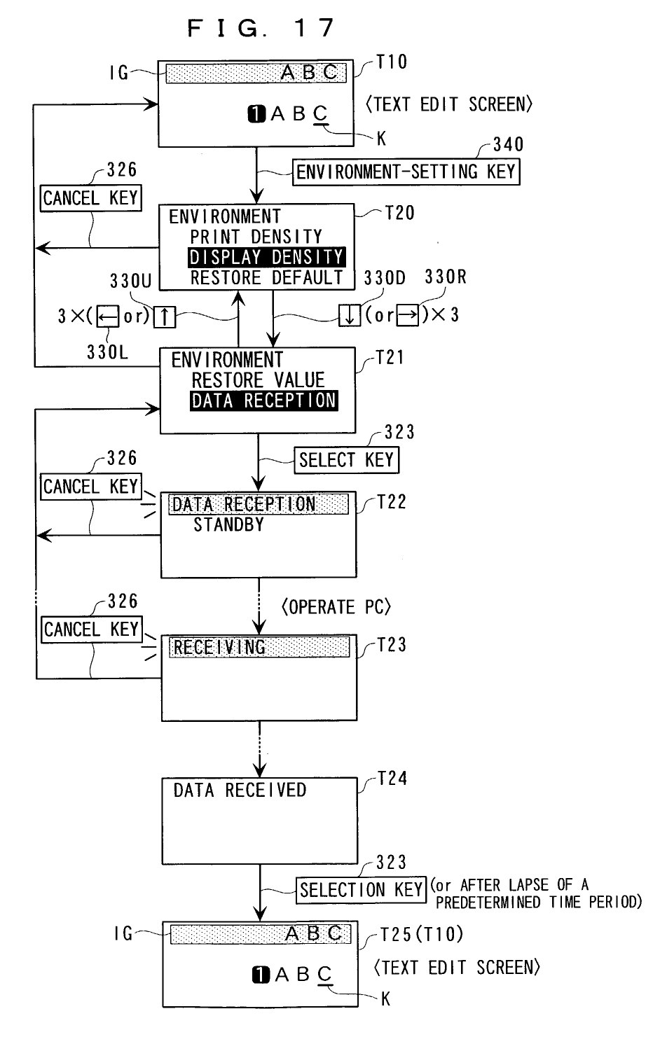

On the other hand, on the side of the personal computer PC (font server FS), e.g., as described above with reference to FIG. 5, when the CD-ROM 501 storing the additional menu data is inserted into a body thereof by the user, the dedicated application 502 exclusively provided for downloading the additional menu data is started. Then, as shown in FIG. 19, first, the personal computer PC displays an initial screen (hereinafter referred to as the “main screen”) D10 for allowing additional menu data to be downloaded by the tape printing apparatus 1 (screen D10: hereinafter, contents displayed on a display screen of a display of the personal computer PC are referred to as the “screen D??” and the reference numerals for the screens are shown and described only by using D??). On the main screen are shown buttons for processes and menu options for data to be downloaded, for user's selection. (D10).

The buttons for selecting processes include “TERMINATION” to be selected when the screen is switched to the original state (original screen), and “TRANSFER” to be selected to shift the computer PC to a data transfer mode for carrying out a data transfer process (downloading by the tape printing apparatus). Further, the menu options for selecting data to be downloaded (additional menu data) include “SHOP”, “SCHOOL”, “CNSTRCTN” (short for CONSTRUCTION), “HOSPITAL”, “OTHERS”, and “G SYMBOL” (short for GUIDE SYMBOL).

In this example, in order to carry out the downloading process, the user can select, for instance, the menu option “SHOP” (default) by clicking the mouse or operating the cursor key, and then select the button “TRANSFER” by clicking the mouse, thereby switching the screen to a data transfer confirmation screen (D11). On this confirmation screen are displayed buttons of “OK” and “CANCEL” together, e.g., with a message “Data of “SHOP” will be allowed to be downloaded to the apparatus”. In the message, the name of the kind of to-be-downloaded data selected (name of a menu option: “SHOP” in this example) is placed between double quotation marks “ ” (D11).

In the above state (D11), when “CANCEL” is clicked, the screen is returned to the original main screen (D10). Here, when “OK” is clicked so as to allow data of the option “SHOP” to be downloaded, the process proceeds to a step S50 in which detection of the apparatus is carried out as internal processing by transmitting and receiving control signals between the personal computer PC and the tape printing apparatus 1. When the tape printing apparatus 1 is not connected to the PC, or when the power of the apparatus is OFF, in other words, when the apparatus is not in the “data reception standby state” (T22 in FIG. 17) (NG to S50), a message “Apparatus is not connected.” is displayed, and the user is prompted to click “CANCEL” (D14). The screen is returned to the main screen (D10) by clicking “CANCEL”.

The above communication process is described hereinafter. As shown in FIG. 20, the personal computer PC notifies the tape printing apparatus 1 of the “start of communication” (Q00: connection is confirmed by transmission and reception of a USB signal used in the communication: hereinafter a signal in the direction of the PC the apparatus is indicated by Q??, and a signal in the reverse direction is indicated by R??). In the tape printing apparatus 1, the screen is switched to display “RECEIVING” (T23 in FIG. 17) when the apparatus has received the notification.

Referring to FIGS. 19 and 20, when a result of the detection of the apparatus (“DETECT APPARATUS”) is OK (communication is started), next, a free area of the memory is checked in a step S51. To do this, the personal computer PC delivers a “search request” for searching for a free area of the downloaded data area 223 (Q01), and the tape printing apparatus 1 sends a “search response” in response to the search request (R00). The “search response” is caused to include information of the aforementioned Valid_Flag VF, that is, the Valid_Flag VF (of Bit 15 (most significant bit)) of the data presence/absence table (having the same format as shown in FIG. 7) stored in the data presence/absence table area 246 in the RAM 240.

If the data is valid (Valid_Flag VF=1) (NG to S51), the personal computer PC displays a confirmation message “Overwrite data already downloaded ?”, together with the buttons “OK” and “CANCEL” (D15). Here, even if “OK” is clicked once, a reconfirmation message is further displayed, and the buttons “OK” and “CANCEL” are displayed again (D16). If “CANCEL” is clicked in either of the above states, the screen is returned to the main screen (D10), while if “OK” is clicked in both of the above states, the same process as carried out when the Valid_Flag VF=0 holds (OK to S51) is executed.

More specifically, when the Valid_Flag VF=0 holds (OK to S51), or when overwriting is “OK” (OK to D15, D16), a message that data is being transferred, and an elapsed time period are displayed (D12).

In this case, first, the personal computer PC delivers a “deletion request” for requesting clearing of the downloaded data area 223 (Q02). In response to this, the tape printing apparatus 1 resets the Valid_Flag VF, copies a “clearing program” for clearing the downloaded data area 223 and a “writing program” for writing a new program, from the ROM 220 to the RAM 240, starts the “clearing program” copied to the RAM 240 to clear the downloaded data area 223, and sends a result of the clearing operation to the personal computer PC as a “deletion response” (R01).

Next, the personal computer PC sends a “registration request” for requesting registration (writing) of data of 8 Kbytes of a first block (block 1) (Q10), and then sequentially delivers registration data items (Q11 to Q1n: n designates a registration data number in each block). Responsive to this, the tape printing apparatus 1 sequentially receives the registration data items, i.e. to-be-registered (downloaded) data items, to store the same in the receiving buffer 281, stores the data items in the RAM 240 whenever the receiving buffer 281 is filled with the data items, starts the “writing program” copied to the RAM 240 when the data of 8 Kbytes have been stored, to write the data items in the downloaded data area 223, and checks the check sum of all the registration data items when a last data item is written. If a result of the checking operation is “NG”, the error message “COM ERROR!” is displayed (T26: see FIG. 18C), whereas if the result of the checking operation is “OK”, the Valid_Flag VF is set and a result of the writing operation is sent to the personal computer PC as a “registration response” (R11).

The above sequence of the step of the personal computer PC delivering the “REGISTRATION REQUEST” to the step of the tape printing apparatus 1 sending the “REGISTRATION RESPONSE” is repeatedly carried out for block 2 to block k (k designates a last block: k is 16 at the maximum). As to the last block k, the same data transfer operation is carried out on the remaining amount (mK bytes: m is 8 at the maximum) of the registration data (Q20 to Rk1 in FIG. 20). Finally, when a “data validity check request” is made by the personal computer PC (Qz0), the tape printing apparatus 1 sends information of the Valid_Flag VF as a “data validity check response” (Rz0). Upon reception of the “data validity check response”, the personal computer PC displays a message “Data transfer completed”, prompts the user to click “OK” for confirmation (D13), and returns the screen to the original screen in response to the clicking. Further, the tape printing apparatus 1 displays a message of “Data reception completed” in response to the notification “End of communication” from the personal computer PC (Qz1), restores the automatic power-off, and returns to the text edit screen (T25: the same as T10).

By the downloading process described above, font data of image elements are stored, e.g., in a state described above with reference to FIGS. 8 to 10, whereby it is possible to find and select font data of desired image elements by using the menu structure described above with reference to FIGS. 11 to 14. In the following, the method of finding and selecting font data of desired image elements will be described in more detail.

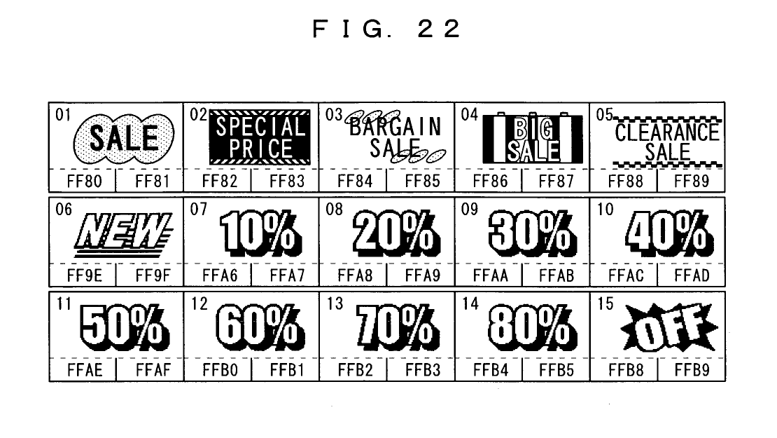

As described above with reference to FIGS. 8 to 10, FIG. 12 and so forth, image elements to be added in the present embodiment are classified into symbols (guide symbols), illustrations, frames, etc. Now, first, the image elements of the “SHOP” (as a business categorical menu, referred to hereinafter) selected on the main screen (D10) in FIG. 19 are described by way of example. For convenience of description, the menu options “ILLUST” (illustration), “FRAME”, and “SYMBOL” are described in the mentioned order. When image elements are configured as shown in an example of FIGS. 21A and 21B, “SHOP” can be added, as a lower level menu option, to options of the menu “ILLUST”, and “illustrations” (pictographs, symbols) as shown in FIG. 22 can be added as options (as image elements) at a level hierarchically immediately under the menu option of “SHOP” (see FIG. 26). In the present embodiment, a menu option of a business categorical menu (in the present example, “SHOP”) is added also at the first hierarchical level, thereby enabling one of image elements under the menu option to be readily selected.

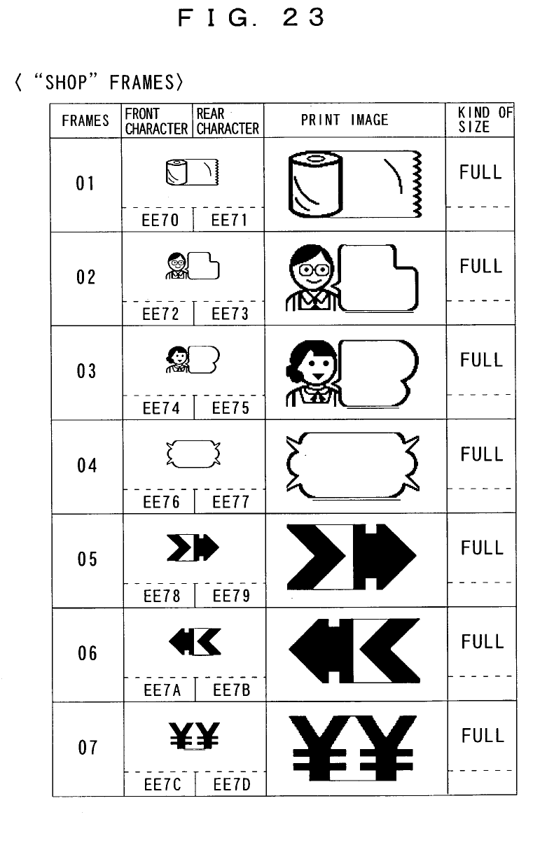

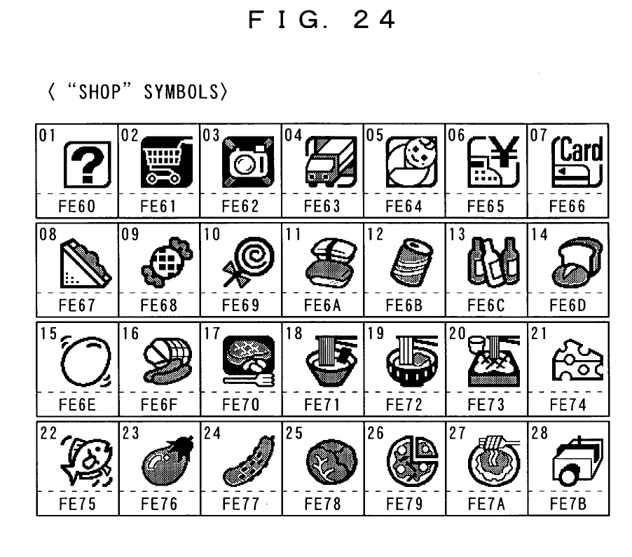

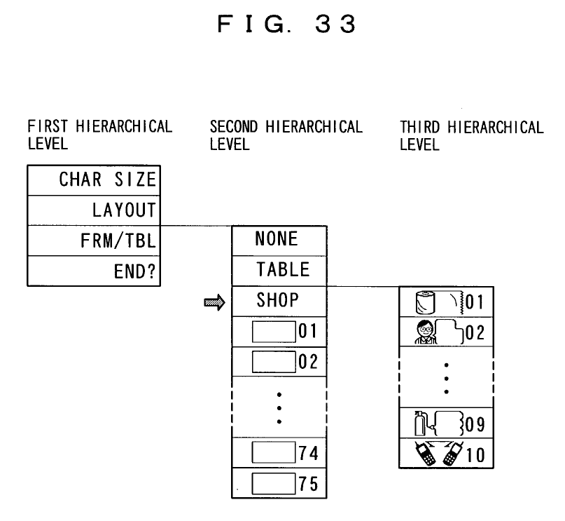

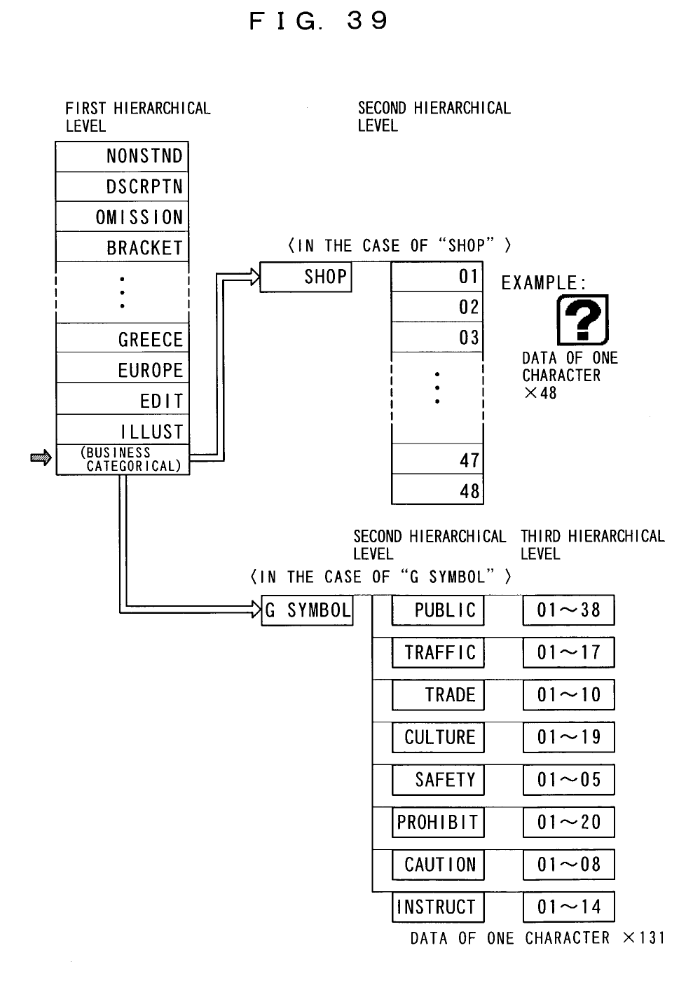

Similarly, when image elements are configured as shown in an example of FIGS. 21C and 21D, “SHOP” can be added to options of the menu of “FRAME” for allowing the same to be selected as a menu (option) at the hierarchically immediately lower level, and “frames” as shown in FIG. 23 can be added as options at the level hierarchically immediately under the menu option of “SHOP” as image elements (see FIG. 33). Further, similarly, when image elements are configured as shown in an example of FIGS. 21E and 21F, “SHOP” can be added, as a lower level menu option, to options of the menu of “SYMBOL”, and “symbols” as shown in FIG. 24 can be added as options (as image elements) at a level hierarchically immediately under the menu option “SHOP” (see FIG. 39).

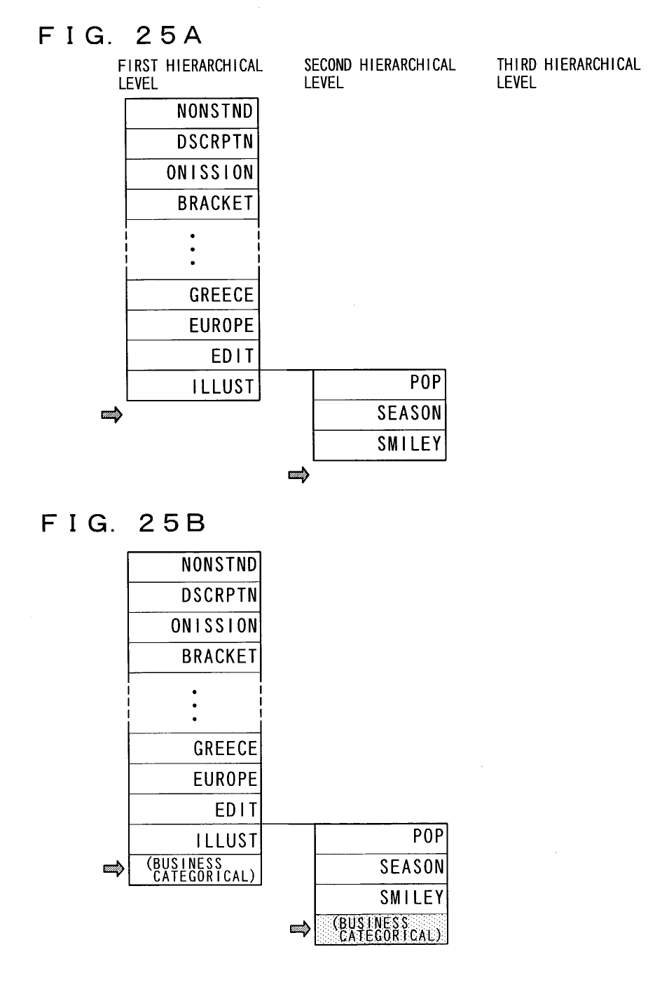

In the present embodiment, the menu option of “ILLUST”, for instance, is set as a menu option which becomes an option positioned at the same hierarchical level as options hierarchically immediately under the menu option of “SYMBOL”, that is, options of “NONSTND” (nonstandard character), “DSCRPTN” (description), “OMISSION”, “BRACKET”, . . . , “GREECE”, “EUROPE”, “EDIT”, and the like. When there is not added a business categorical menu option, such as “SHOP”, as shown in FIG. 25A, options hierarchically immediately under the menu option “ILLUST” are “POP”, “SCENE”, “SMILEY”, and so forth, whereas when menu options are added (when additional menu data has been downloaded), as shown in FIG. 25B, the business categorical menu option is added to the options hierarchically immediately under the menu option “ILLUST”. More specifically, when (the menu option of) “SHOP” is added, as shown in FIG. 26, a menu structure consisting of three hierarchical levels of “ILLUST”—“SHOP”—“Illustrations of “SHOP” can be formed such that each illustration can be selected for use as an image element.

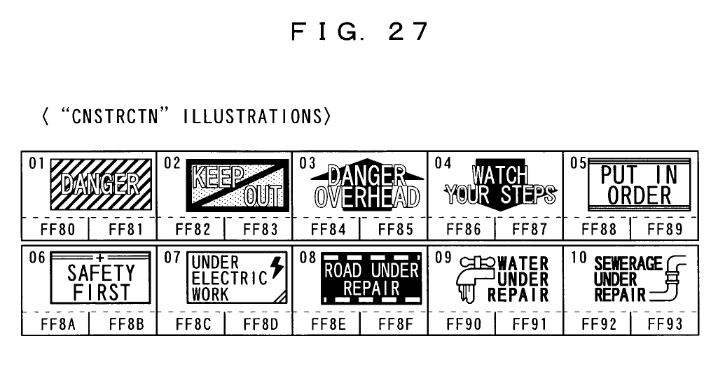

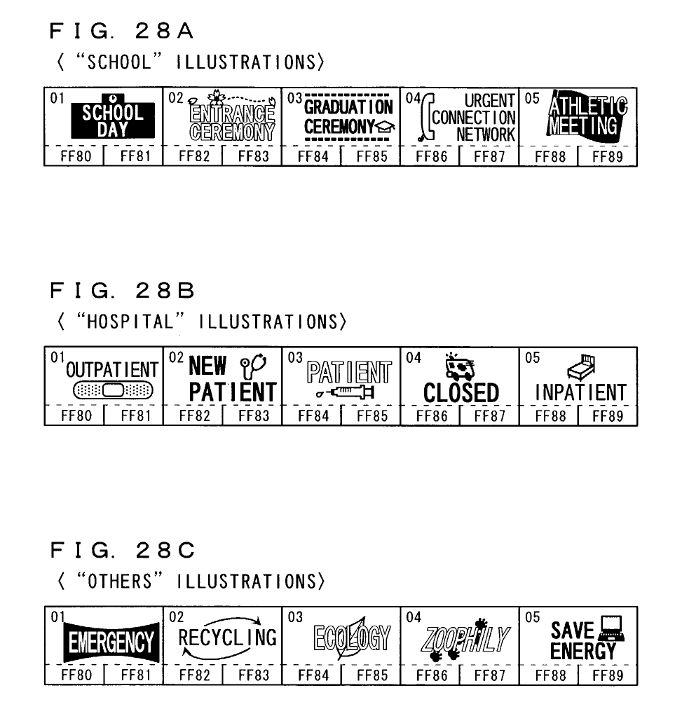

It should be noted that when any of the other options “SCHOOL”, “CNSTRCTN” (CONSTRUCTION), “HOSPITAL”, and “OTHERS” appearing on the main screen (D10) in FIG. 19 is selected, if image elements are configured according to the example of FIGS. 21A and 21B, similarly to FIG. 22, “illustrations” shown, e.g., in FIG. 27 (“CNSTRCTN”) (construction), FIG. 28A (“SCHOOL”), FIG. 28B (“HOSPITAL”), or FIG. 28C (“OTHERS”) can be used (selected) as image elements.

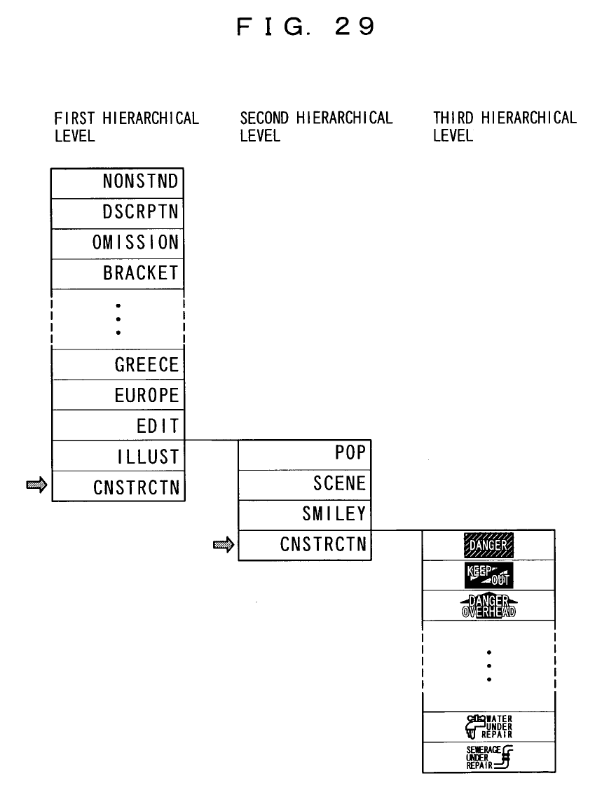

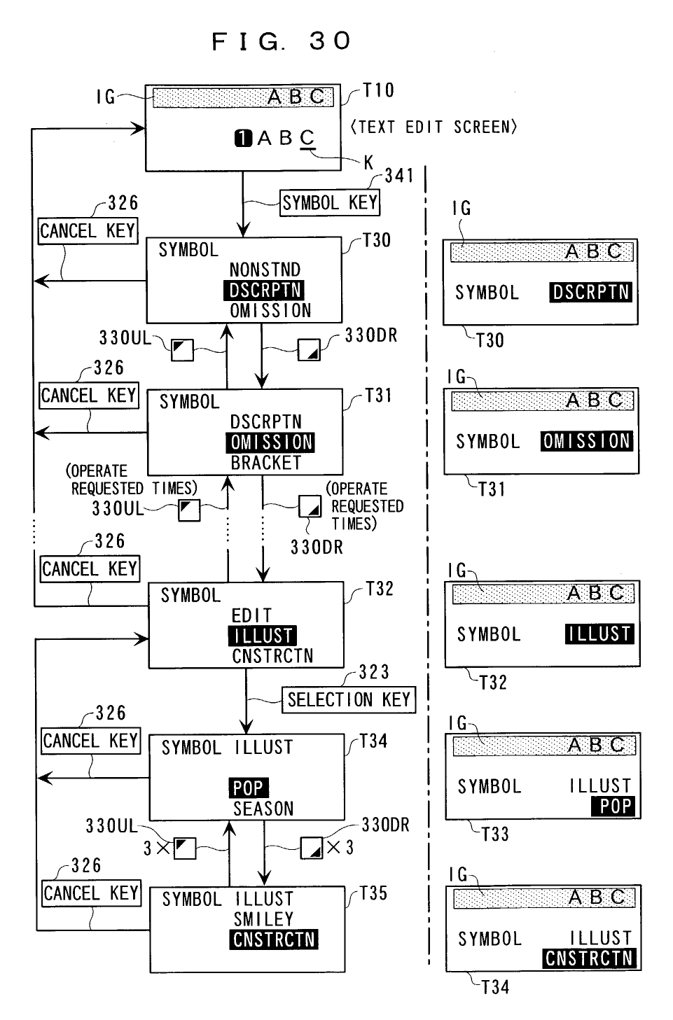

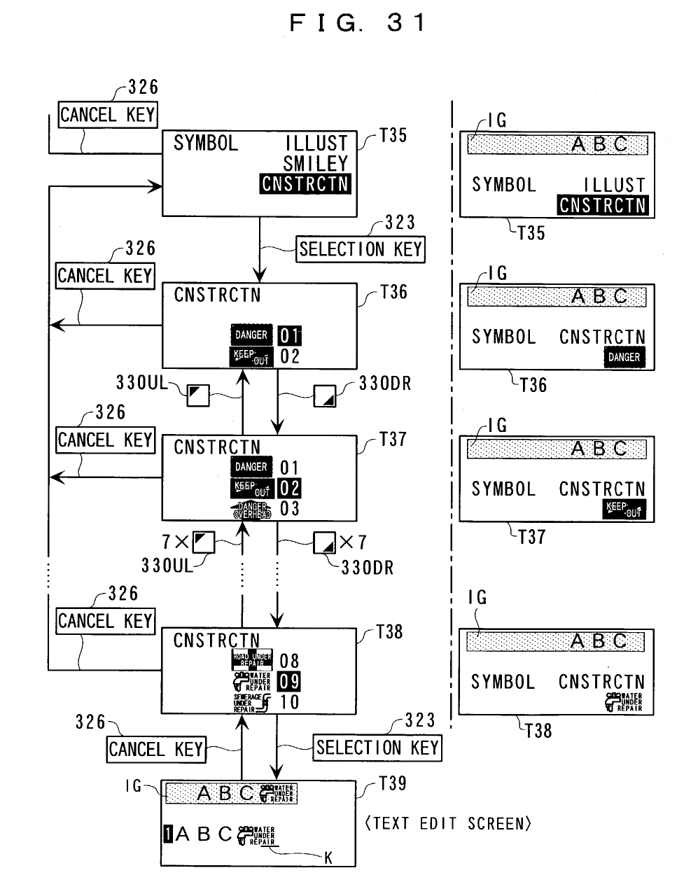

For instance, when the option “CNSTRCTN” is selected as an option other than “SHOP” (i.e. if additional menu data of “CNSTRCTN” is downloaded), as shown in FIG. 29, a menu consisting of three hierarchical levels of “ILLUST”—“CNSTRCTN”—“illustrations of “CNSTRCTN” can be used. In this case, for instance, as shown in FIG. 30, when the symbol key 341 is depressed by the user in the state of the text edit screen being displayed (T10: the same as T10 in FIG. 16), a selection screen at a level hierarchically immediately under the option “SYMBOL” is displayed (T30). On this selection screen, options, such as “NONSTND”, “DSCRPTN”, “OMISSION”, “BRACKET”, . . . “GREECE”, “EUROPE”, “EDIT”, as well as “ILLUST” are displayed. Further, the selection screen may be configured such that the user can view the print image thereon, similarly to the text edit screen, while displaying one option (image element) on the same (see a right-hand column in FIG. 29: the same applies to FIGS. 31, 43, and 48).

Now, from the above state (T30), when the option “ILLUST” is highlighted for selection (T30 to T32), by the user's operation of the cursor key, and selected by depression of the selection key 323, a selection screen (menu screen) hierarchically immediately under the option of “ILLUST” is displayed (T34). On this selection screen, options of “CNSTRCTN” as well as “POP”, “SCENE”, and “SMILEY”, for instance, can be displayed (T34, T35), and hence from the state of “CNSTRCTN” being highlighted for selection (T35: commonly shown in FIGS. 30 and 31), when the selection key 323 is depressed, as shown in FIG. 31, a selection screen (menu screen) hierarchically immediately under the option of “CNSTRCTN” is displayed (T36).

On the above selection screen, a candidate for an “illustration” to be employed as an image element can be displayed as an option (T36 to T38). Hence, when, e.g., an option “ILLUST NO. 09” is highlighted for selection (T38), and selected, the selection screen is switched to the text edit screen on which the selected illustration is inserted into a cursor position indicated by the cursor K, of a character string (text string) being edited (T39). In short, the user can insert (arrange) a desired illustration (illustration designated by the option “CNSTRCTN_ILLUST No. 09”, in the present example) into the character string, as an image element of the print image.

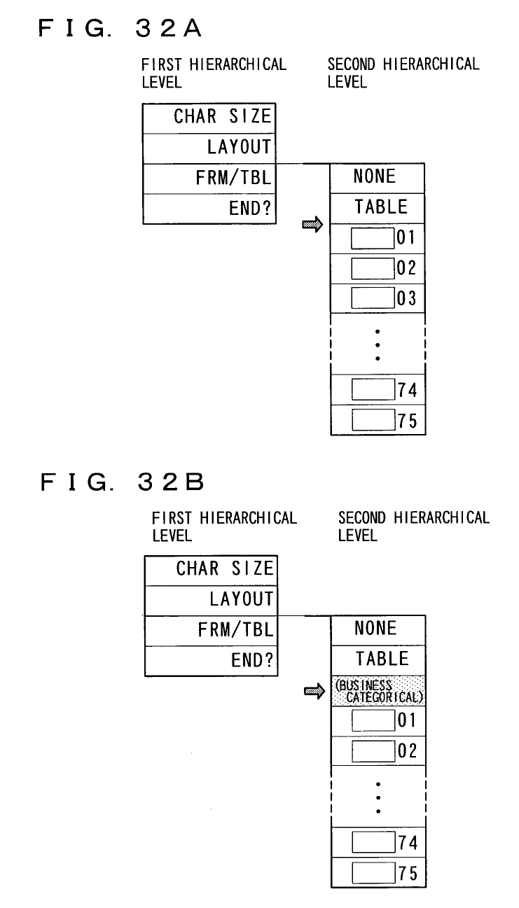

Next, in the present embodiment, the menu option of “FRAME” is set as a menu option which becomes an option positioned at the same hierarchical level as options hierarchically immediately under a menu option of “STYLE” (paragraph style), that is, “CHAR SIZE” (character size), “LAYOUT”, and other options. The “FRAME” is used as an option of “FRM/TBL” (short for “FRM/TBL”) in combination with a menu option of “TABLE”. When there is not added a business categorical menu option, such as “SHOP” or the like, as shown in FIG. 32A, options hierarchically immediately under the menu option “FRM/TBL” are “NONE”, “TABLE”, and numerical options “01” to “75” indicative of existing frames, whereas when a business categorical menu option is added, as shown in FIG. 32B, the business categorical menu option is added to the options hierarchically immediately under the menu option “FRM/TBL”. More specifically, when the menu option of “SHOP” is added, as shown in FIG. 33, a menu structure consisting of three hierarchical levels of “FRM/TBL”—“SHOP”—“illustrations of “SHOP” can be formed, thereby enabling a desired one of the frames to be selected as an image element.

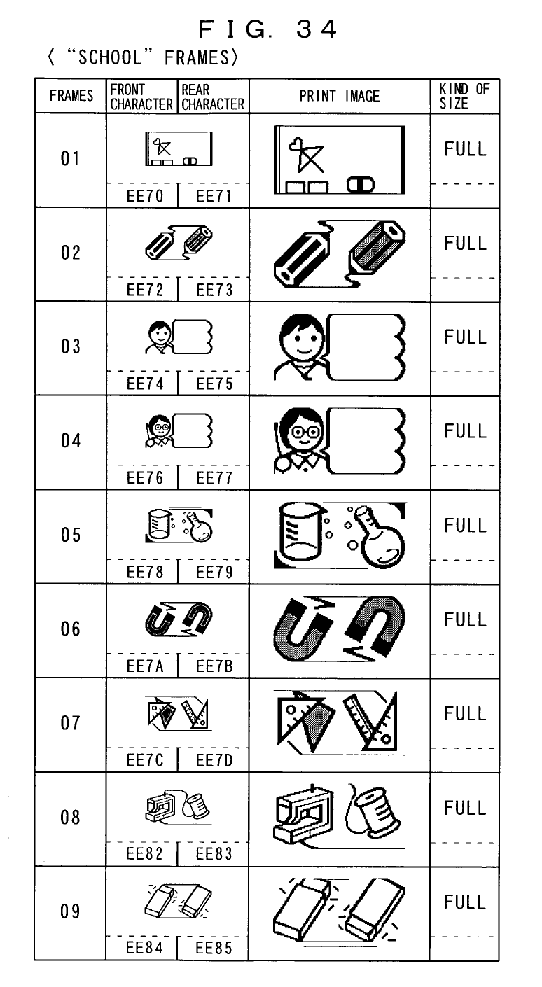

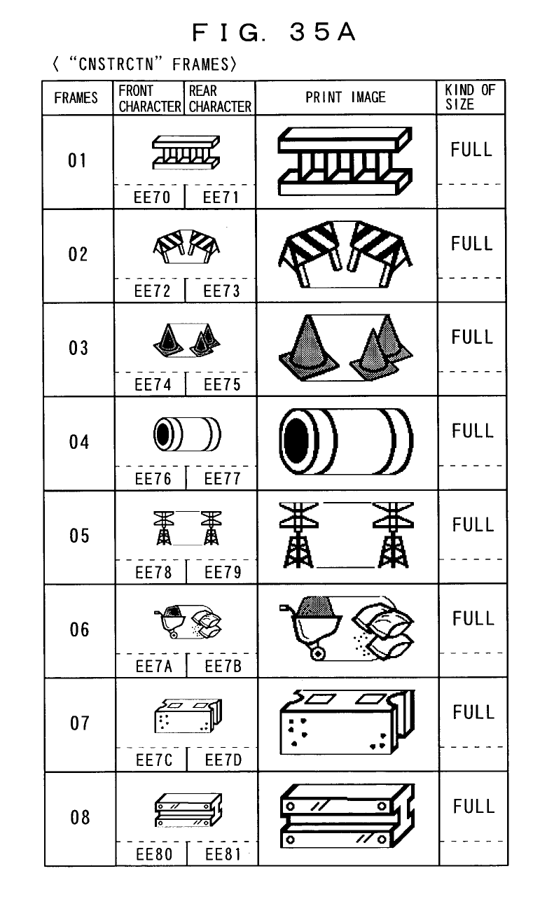

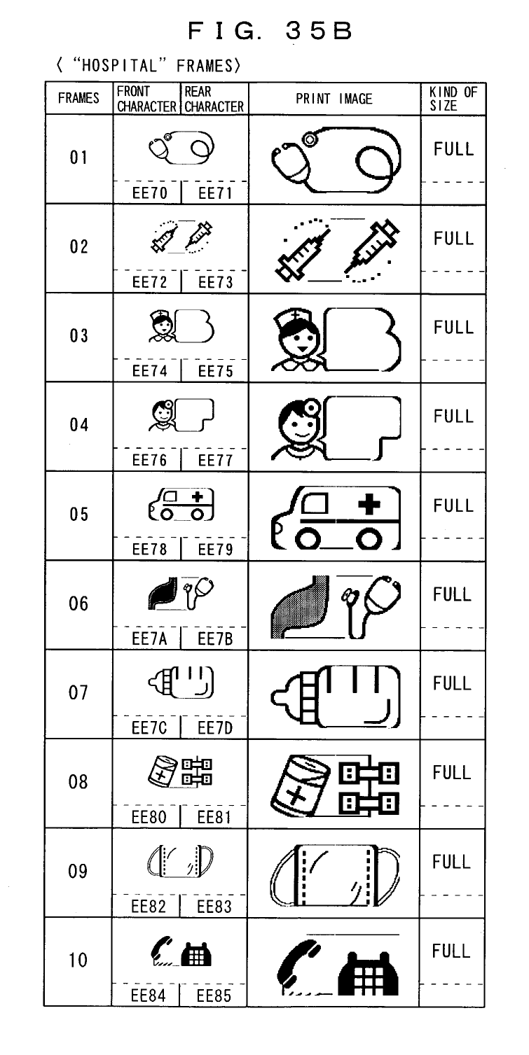

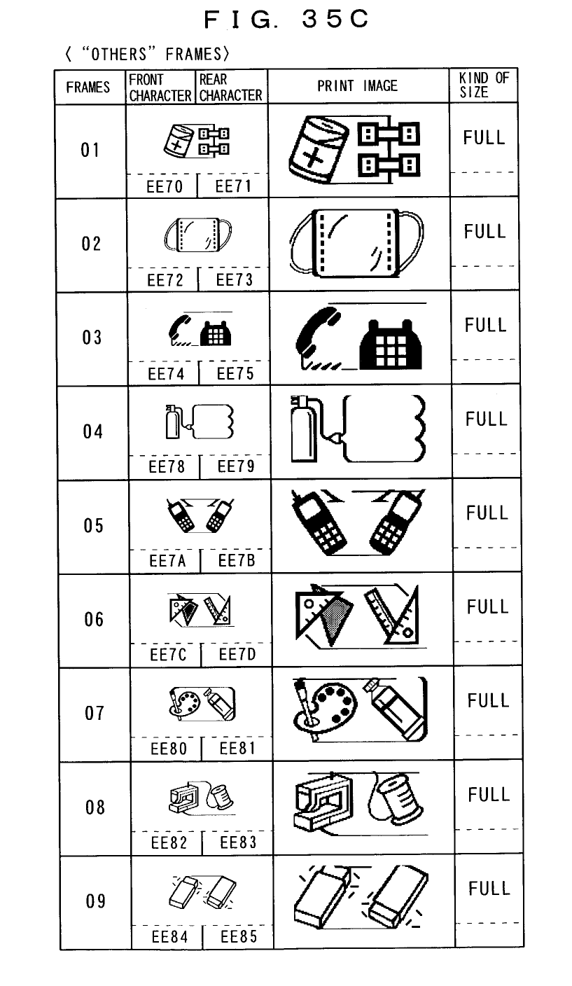

It should be noted that when any of the other options “SCHOOL”, “CNSTRCTN”, “HOSPITAL”, and “OTHERS” appearing in FIG. 19 is selected, if image elements are set according to FIGS. 21C and 21D similarly to FIG. 23, “frames” shown, e.g., in FIG. 34 (“SCHOOL”), FIG. 35A (“CNSTRCTN”), FIG. 35B (“HOSPITAL”), or FIG. 35C (“OTHERS”) can be used (selected) as image elements.

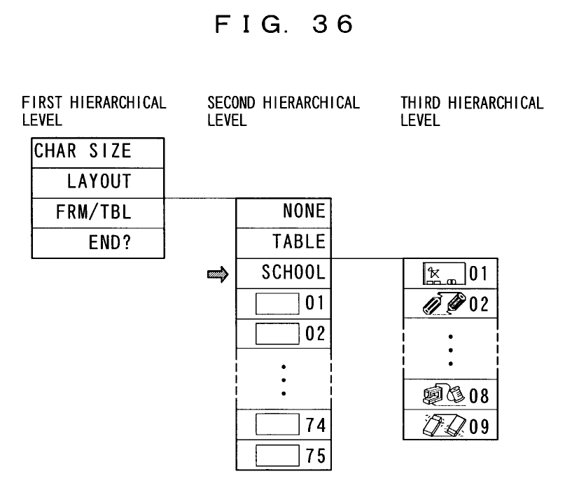

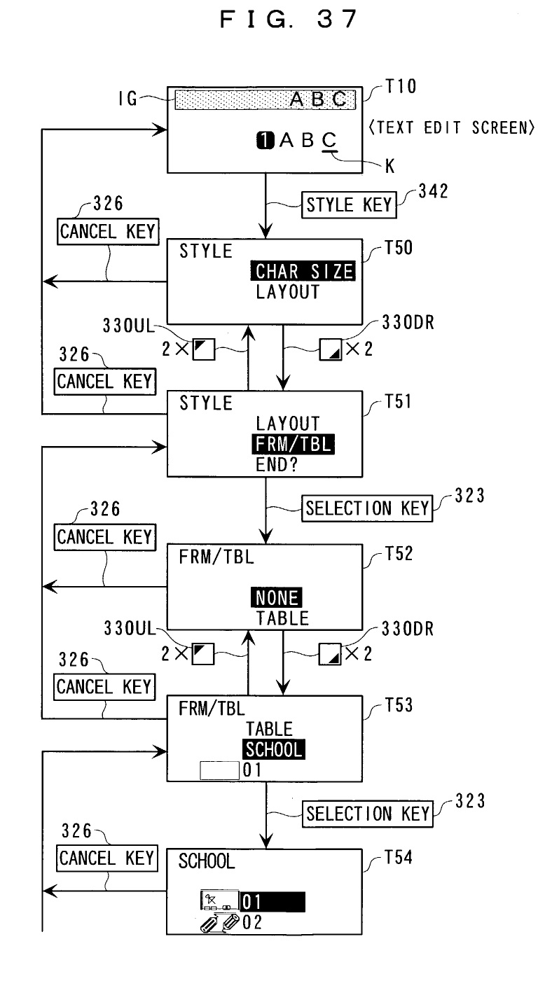

For instance, when the additional menu data of “SCHOOL” is downloaded as an option other than “SHOP”, as shown in FIG. 36, a menu consisting of three hierarchical levels of “FRM/TBL”—“SCHOOL”—“frames of “SCHOOL” can be made use of. In this case, for instance, as shown in FIG. 37, when the style key 342 is depressed by the user in the state of the text edit screen being displayed (T10: the same as T10 in FIG. 16), a selection screen at a level hierarchically immediately under the menu option “STYLE” is displayed (T50). On this selection screen, options, such as “CHAR SIZE”, “LAYOUT”, “FRM/TBL”, and “END ?” are displayed.

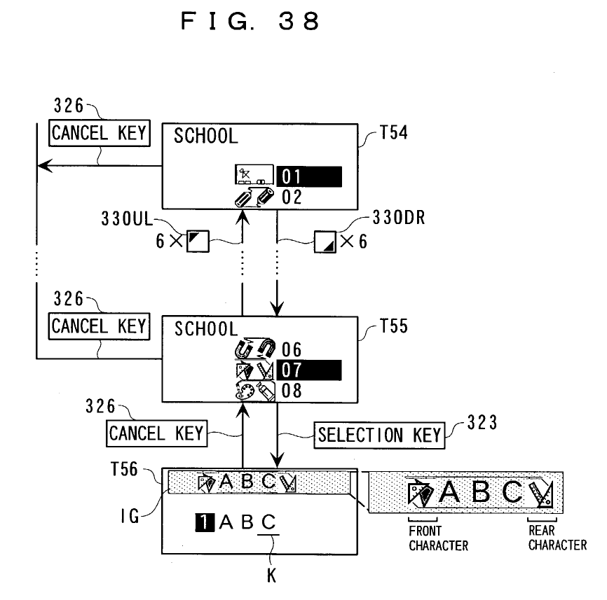

From the above state (T50), when the menu option “FRM/TBL” is highlighted for selection (T50, T51), by the user's operation of the cursor key, and selected by depression of the selection key 323, a menu selection screen hierarchically immediately under the option of “FRM/TBL” is displayed (T52). On this selection screen, options of “SCHOOL” as well as “NONE”, “TABLE”, numerical options “01” to “75” indicative of the existing frames, and the like, can be displayed (T52, T53), and hence from the state of “SCHOOL” being highlighted for selection (T54: commonly shown in FIGS. 37 and 38), when the selection key 323 is depressed, a menu selection screen hierarchically immediately under the menu option of “SCHOOL” is displayed (T54).

Referring to FIG. 38, on the above selection screen, a candidate for a “FRAME” as an image element of the menu option “SCHOOL” can be displayed as an option (T54, T55). Hence, for instance, when an option “FRAME NO. 07” is highlighted for selection (T55), and selected, the selection screen is switched to the text edit screen on which the selected “FRAME” is arranged (drawn) such that a “front character” and a “rear character” of the frame sandwiches the character string being edited, and top and bottom sides of the front and rear characters are connected to enclose the character string. In short, the user can arrange a desired outer frame of “SCHOOL”, designated by the option “OUTER FRAME NO. 07”, as an image element of the print image.

Next, in the present embodiment, as shown in FIG. 39, the business categorical menu option of “SHOP” or the like is set as a menu option which becomes an option at the same hierarchical level as options hierarchically immediately under the menu option of “SYMBOL”, that is, options of “NONSTND”, “DSCRPTN”, “OMISSION”, “BRACKET”, . . . , “GREECE”, “EUROPE”, “EDIT”, and “ILLUST”. When the business categorical menu option is not added, menu options hierarchically immediately under the menu option “SYMBOL” are from “NONSTND” to “ILLUST”, but the business categorical menu option of “SHOP” or the like is not displayed. Only when additional menu data is added, the business categorical menu option is added for display. More specifically, when the menu option of “SHOP” is added, a menu structure consisting of two hierarchical levels of “SHOP” hierarchically immediately under “SYMBOL”—“symbols of “SHOP” can be formed, thereby enabling a desired one of symbols of “SHOP” to be selected as an image element.

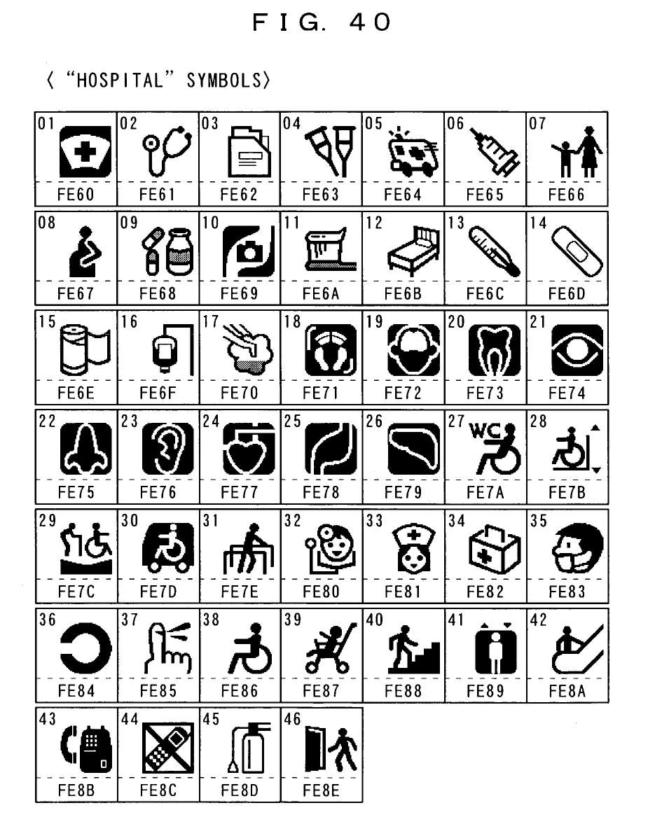

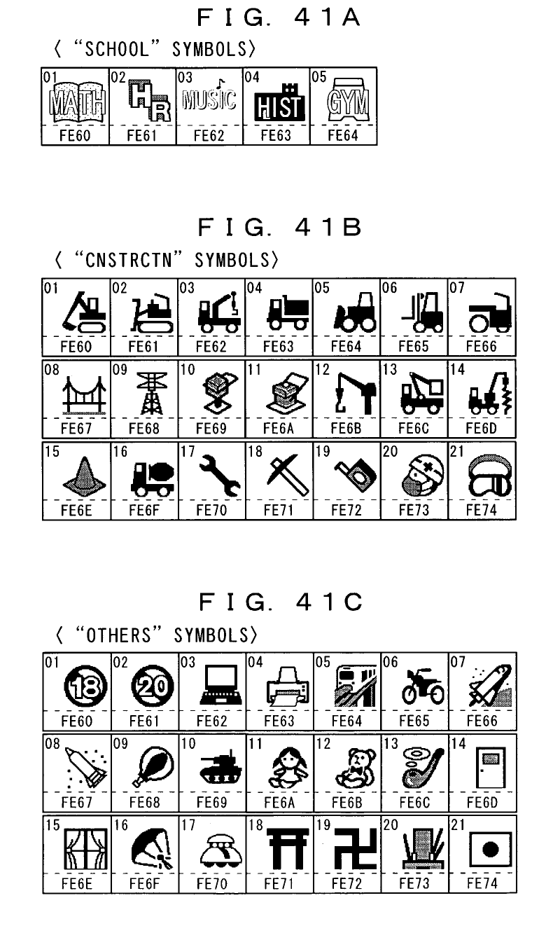

It should be noted that when any of the other menu options “SCHOOL”, “CNSTRCTN”, “HOSPITAL”, and “OTHERS” appearing in FIG. 19 is selected, if image elements are configured according to FIGS. 21E and 21F similarly to FIG. 24, “symbols” shown, e.g., in FIG. 40 (“HOSPITAL”), FIG. 41A (“SCHOOL”), FIG. 41B (“CNSTRCTN”), or FIG. 41C (“OTHERS”) can be used as image elements.

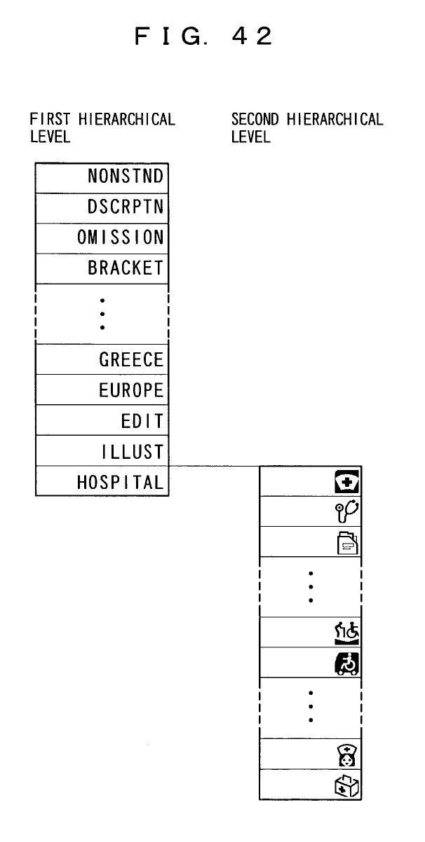

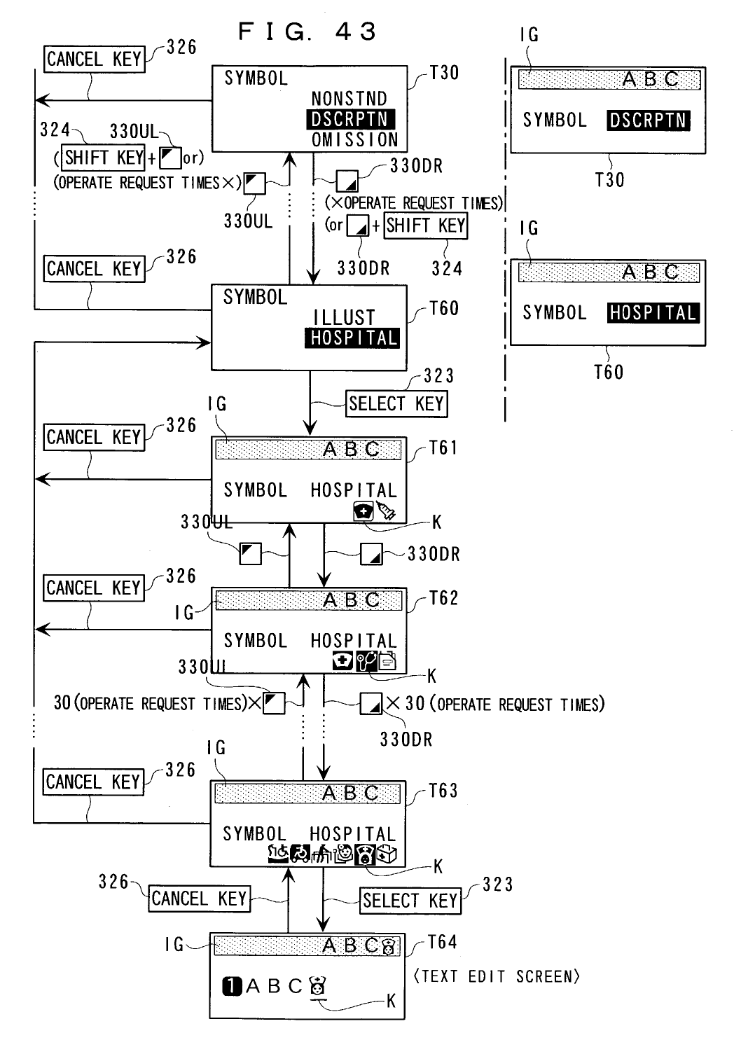

For instance, when the menu option “HOSPITAL” is selected as an option other than “SHOP”, as shown in FIG. 42, a menu consisting of two hierarchical levels of “HOSPITAL”—“symbols of “HOSPITAL” under the menu option “SYMBOL” can be used. In this case, for instance, as shown in FIG. 43, from the state of the menu selection screen hierarchically immediately under the menu option “SYMBOL” being displayed (T30), which is the same selection screen as described above with reference to FIG. 30, when the menu option “HOSPITAL” is highlighted for selection (T60) by the user's operation of the cursor key and selected, a selection screen at a level hierarchically immediately under the menu option “HOSPITAL” is displayed (T61). It should be noted that to move the cursor from any position of the menu to an end thereof (T60), simultaneous depression of the shift key 324 and the cursor key 330DR may be employed, whereas to move the cursor to the top of the menu (T30), the simultaneous depression of the shift key 324 and the cursor key 330UR may be employed.

On the above selection screen positioned at the level hierarchically immediately under the menu option of “SYMBOL”—“HOSPITAL”, it is possible to display as options a maximum of six candidates for “symbols” for use as image elements (T61 to T63), while displaying a print image in the image area IG similar to the text edit screen. Therefore, for instance, when an option “SYMBOL No. 33” is highlighted for selection (T63), and selected, the selection screen is switched to the text edit screen on which the selected symbol is inserted into a cursor location indicated by the cursor K, of a character string (text string) being edited (T64). In short, the user can arrange a desired one of symbols of the “HOSPITAL”, designated by the option “SYMBOL No. 33”, as an image element of the print image.

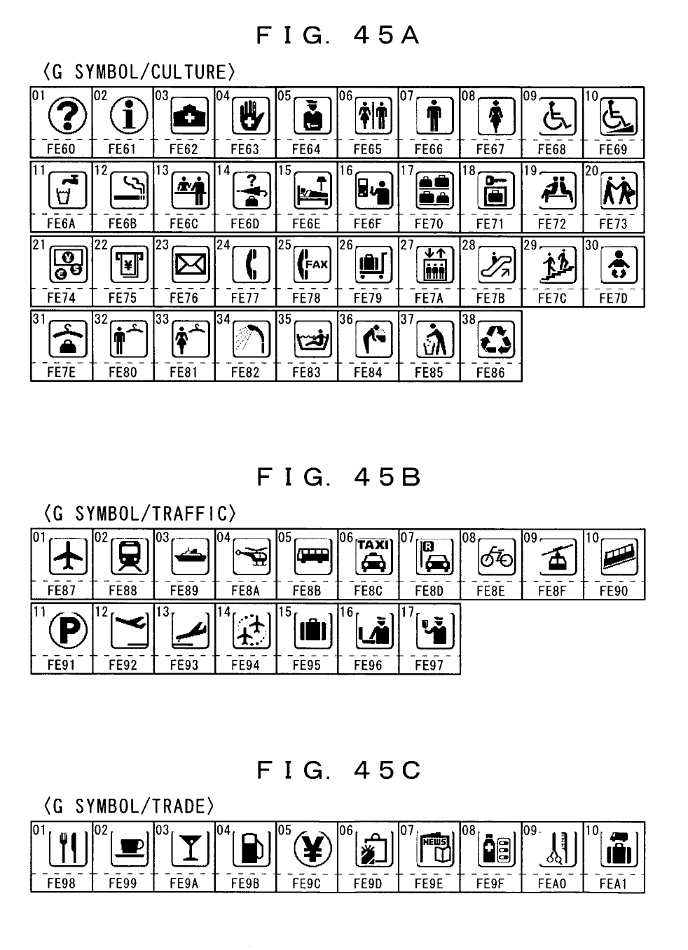

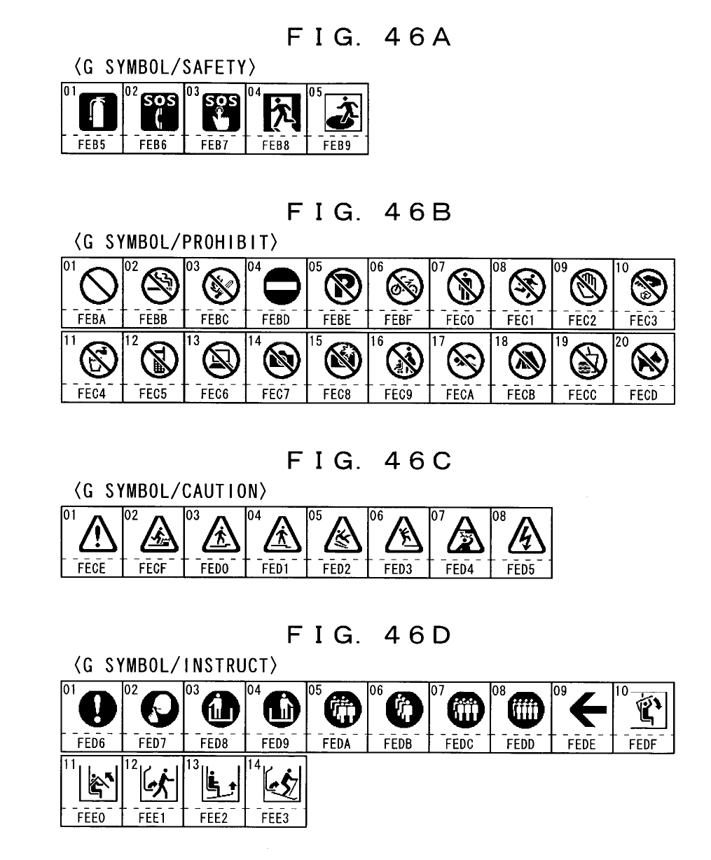

Next, in the present embodiment, as shown in FIG. 39, the menu option “G SYMBOL” (guide symbol) can be selected as the option of “SYMBOL”. When “G SYMBOL” is selected as an option other than the menu option “SHOP”, “guide signals” as shown in FIG. 44 (CULTURE), FIG. 45A (PUBLIC), FIG. 45B (TRAFFIC), FIG. 45C (TRADE), FIG. 46A (SAFETY), FIG. 46B (PROHIBIT), FIG. 46C (CAUTION), and FIG. 46D (INSTRUCT) can be employed as image elements. However, in the present embodiment, as described above with reference to FIG. 10, when “G SYMBOL” (guide symbol) is selected, the image elements of “ILLUST” and “FRAME” corresponding thereto do not exist, and hence downloading thereof is not carried out.

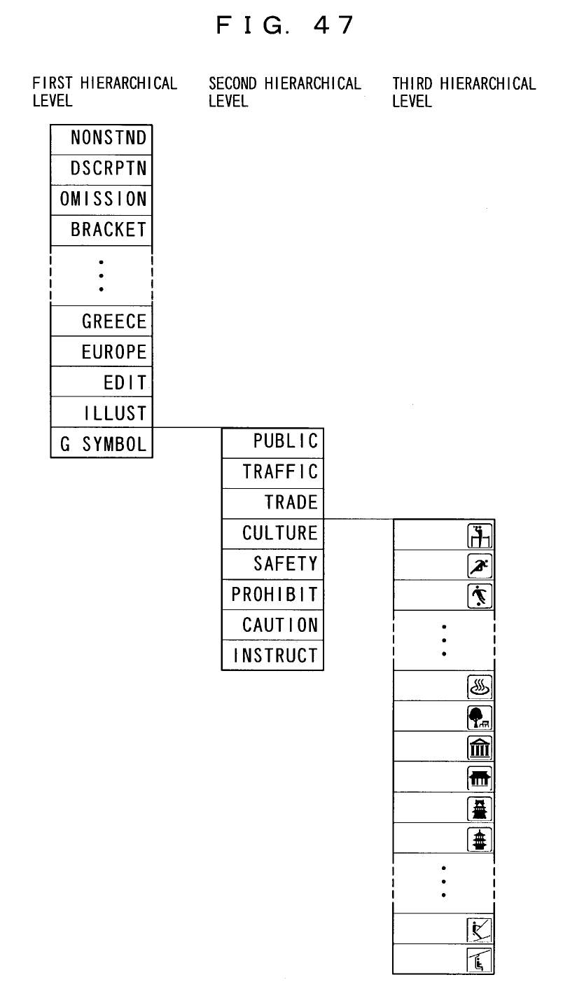

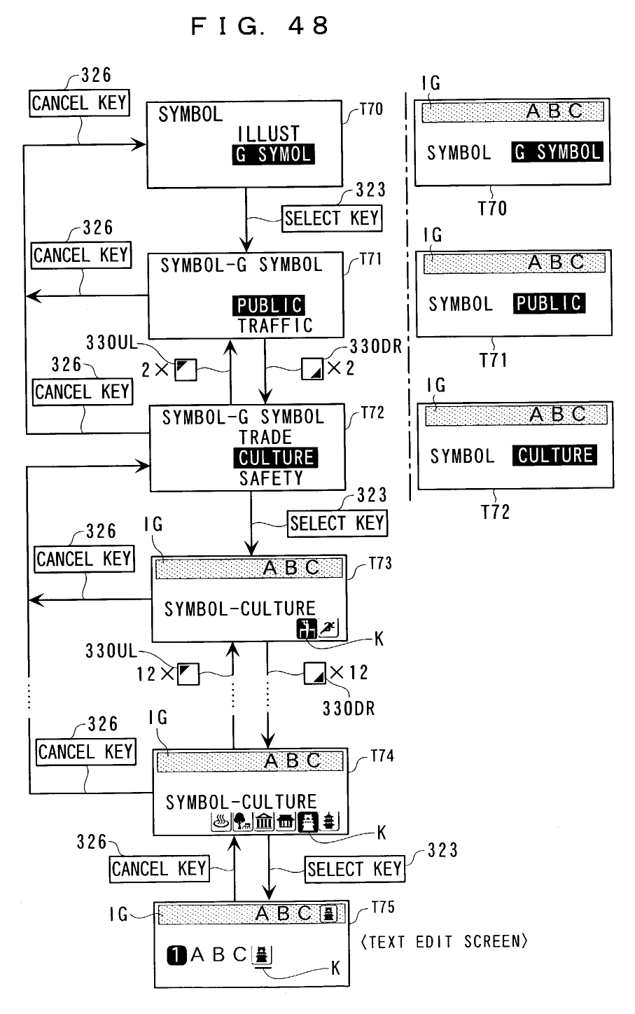

For instance, when the menu option “G SYMBOL” is selected and then an option “CULTURE” positioned at a level hierarchically immediately under “G SYMBOL” is selected, as shown in FIG. 47, it is possible to use a menu which consists of three hierarchical levels of “G SYMBOL” immediately under “SYMBOL”—“CULTURE”—“guide symbols of “CULTURE”. In this case, as shown in FIG. 48, from the state of the menu selection screen hierarchically immediately under the menu option “SYMBOL” being displayed (T70), which is the same as the FIG. 30 menu selection screen (T30), when the option “CULTURE” is highlighted for selection (T71, T72) by operation of the cursor key and selected, a selection screen at a level hierarchically immediately under the menu option “CULTURE” is displayed (T73).

On the above selection screen as well, it is possible to display as options a maximum of six candidates for “guide symbols” for use as image elements (T73, T74), while displaying a print image in the image area IG similar to the text edit screen. If an option “SYMBOL No. 13” is highlighted for selection (T74), and selected, the selection screen is switched to the text edit screen on which the selected guide symbol is inserted into a position of the cursor K, of the character string being edited (T75). In short, the user can arrange a desired one of symbols of the “GUIDE SYMBOL/CULTURE”, designated by the option “SYMBOL No. 13”, as an image element of the print image.

As described hereinabove, in the tape printing apparatus 1 according to the present embodiment, additional menu data including menu tables (information of additional menu options) which can be added as menu options, and font data (information of image elements) displayed as options at a level hierarchically immediately under the additional menu options is downloaded (received from a predetermined other end of communication according to a predetermined communication protocol) for storage. This facilitates addition of menu options for selecting image elements for forming a print image to thereby facilitate addition of selectable image elements.

There are various kinds of image elements for forming a print image. Characters and the like different in typeface are different in image element (character image, in this case) even if they correspond to the same standard text code (JIS code, for instance). There are an enormous number of so-called characters, if characters and figures used in countries and further a wide variety of Kanji letters are included therein. As to graphics which include illustrations and symbols, there can exist an infinite number of kinds thereof. Further, image elements necessitated are different depending on users or on the situation. To meet such requirement, the tape printing apparatus 1 according to the present embodiment is capable of easily adding menu options and image elements selectable by using the menu options. Hence, there is no need to store menu options and image elements more than necessary, which makes it possible to reduce the number of menu options and image elements provided as standard menus from the beginning, thereby saving the memory capacity of the apparatus.

Further, since menus having no additional menu options included therein are displayed before reception of additional menu data, and menus including additional menu options are displayed after reception of additional menu data, it is possible to prevent menu options from being stored in advance as reserved ones before receiving image elements thereof. This contributes to prevention of unnatural display of menus, thereby making it possible to provide excellent natural appearance of display of menus before and after reception of additional menu data.

Further, the downloaded data area 223 is defined, and when the downloaded data area 223 has additional menu data stored therein on the immediately preceding occasion, it is possible to delete the data once to write new additional menu data over the same, which makes it possible to replace an additional menu (menu other than the standard menus provided from the beginning) with another additional menu as required without increasing the memory capacity, and easily customize menu options.

Further, as described above with reference to FIG. 11 and so forth, information of additional menu options is defined by the menu table which defines the three kinds of menus, that is, the root menu, the lower level menu-designating menu, and the candidate menu, respectively. Since image elements positioned at a hierarchically lowest level can be found from the root menu, an image element at the hierarchically lowest level can be searched for from the root menu after reception of additional menu data, thereby making it possible to display additional menu options with ease.

Further, since an illustration, a symbol, or the like is arranged at a cursor position (see T39 in FIG. 31, T64 in FIG. 43), a print image can be formed while designating a location for arranging an image element by operating the cursor K.

Although in the aforementioned embodiment, the CD-ROM 501 storing additional menu data is inserted into the personal computer PC (font server FS), described above with reference to FIG. 2, for starting the dedicated application 502 exclusively provided for allowing the additional menu data (see FIG. 5) to be downloaded, this is not limitative, but the dedicated application 502 may be installed in the personal computer PC from the beginning, or alternatively, the application program itself may be stored in the CD-ROM 501 together with the additional menu data such that the dedicated application 502 can be started. In the former case, the additional menu data can be changed into any of various kinds of additional menu data simply by replacing CD-ROMs. Further, in the latter case, if the application is provided as one executable by an operation system (OS) of the general type, additional menus can be added to the tape printing apparatus 1 through execution of the program, if only a CD-ROM having various kinds of additional menu data stored therein is mounted in a personal computer or the like having the OS installed thereon.

Although in the above embodiment, the CD-ROM is employed by way of example, other storage mediums, such as an FD, an MO, a DVD, and the like, may be used. Further, when not the printing system having the FIG. 2 construction, but the printing system using the network constructed as shown FIG. 1 is employed, additional menu data can be received from other devices (WS2, WS3, etc. in the example illustrated in the figure) connected to the network via a host apparatus (PC1 or TA in the example illustrated in the figure), so that various kinds of additional menu data can be downloaded to change additional menu data already stored.

Further, although in the above embodiment, the tape printing apparatus is employed by way of example, this is not limitative, but the present invention can be applied to a different type printing apparatus whose print medium is not a printing tape, so long as it forms a print image by arranging image elements on the print image, for printing. Further, if the above-mentioned program for enabling additional menu data to be downloaded is stored in advance in a storage medium, such as a CD, or the like, by mounting the storage medium in a desired printing apparatus capable of executing the program, and reading out the program for execution, it is possible to easily add menu options to thereby facilitate addition of selectable image elements.

It is further understood by those skilled in the art that the foregoing is a preferred embodiment of the invention, and that various changes and modifications may be made without departing from the spirit and scope thereof.

What is claimed is:

1. A printing apparatus for forming a print image by arranging an image element selected from a displayed menu, in the print image, comprising:
receiving means for receiving additional menu data from a predetermined other end of communication, the additional menu data including information of an additional menu option for being added to the displayed menu as a menu option thereof, and information of an image element displayed as an option hierarchically under the additional menu option;
additional menu-storing means for storing the additional menu data; and
menu-incorporating means for incorporating into the displayed menu the additional menu option and the image element hierarchically under the additional menu option, based on the additional menu data.

2. The printing apparatus according to claim 1, wherein a print medium is a tape.

3. The printing apparatus according to claim 1, wherein said receiving means comprise overwriting means for writing new additional menu data over additional menu data having been stored on an immediately preceding occasion.

4. The printing apparatus according to claim 1, wherein the information of the additional menu option is defined by menu tables for defining three kinds of menus formed by a root menu, a lower level menu-designating menu, and a candidate menu, the root menu being a menu which serves as a root from which the additional menu option is searched, the lower level menu-designating menu being a menu which is designated by the root menu or by another of the lower level menu-designating menu at a hierarchically higher level, and used for designating another of the lower level menu-designating menu or the candidate menu, the candidate menu being a menu which is designated by the root menu or the lower level menu-designating menu, and used for designating the image element as the option hierarchically thereunder, and
wherein after reception of the additional menu data, the additional menu option is displayed by a search made from the root menu as far as the image element at the hierarchically lowest level.

5. The printing apparatus according to claim 1, wherein the additional menu option comprise at least one of menu options of an illustration, a symbol, a frame, and a guide symbol.

6. The printing apparatus according to claim 1, further comprising position-designating means for designating a position in the print image for arranging the selected image element.

7. A printing system comprising: the printing apparatus as set forth in any one of claims 1 through 6; and a supply device for transmitting the additional menu data to said printing apparatus as said other end of communication.

8. The printing system according to claim 7, wherein said supply device comprises:
mounting means capable of mounting a storage medium storing the additional menu data and a program for transmitting the additional menu data to said printing apparatus; and
program-executing means for executing the program stored in the mounted storage medium to transmit the additional menu data to said printing apparatus according to the program.

9. The printing system according to claim 7, wherein said supply device comprises host communication means connected to another device via a predetermined network, for receiving the additional menu data from said another device.

10. A menu-adding method for a printing apparatus that forms a print image by arranging an image element selected from a displayed menu, in the print image,
the menu-adding method comprising the steps of:
receiving additional menu data from a predetermined other end of communication, the additional menu data including information of an additional menu option for being added to the displayed menu as a menu option thereof, and information of an image element displayed as an option hierarchically under the additional menu option;
storing the additional menu data; and
incorporating into the displayed menu the additional menu option and the image element hierarchically under the additional menu option, based on the additional menu data.

11. A storage medium for storing a program capable of executing functions of means of the printing apparatus according to any one of claims 1 through 6.

12. A storage medium for storing a program capable of executing a menu-adding method for the printing apparatus according to claim 10.

13. A printing apparatus for forming a print image by arranging an image element selected from a displayed menu, in the print image, comprising:
a font data interface for receiving additional menu data from a predetermined other end of communication, the additional menu data including information of an additional menu option for being added to the displayed menu as a menu option thereof, and information of an image element displayed as an option hierarchically under the additional menu option;
a control data area for storing the additional menu data; and
a control block for incorporating into the displayed menu the additional menu option and the image element hierarchically under the additional menu option, based on the additional menu data.

14. A printing system comprising:
the printing apparatus according to claim 13; and
a supply device for transmitting the additional menu data to said printing apparatus as said other end of communication.

15. A storage medium for storing a program capable of executing functions of constituting elements of the printing apparatus according to claim 13.
